(19) United States
(12) Patent Application Publication
(10) Pub. No.: US 2026/0210698 A1
(43) Pub. Date: Jul. 23, 2026

(54) DISTANCE MEASURING METHOD

(71) Applicant: Mitsubishi Electric Corporation, Tokyo (JP)

(72) Inventor: Toshiyuki SAWABE, Tokyo (JP)

(73) Assignee: Mitsubishi Electric Corporation, Tokyo (JP)

(21) Appl. No.: 19/157,374

(22) PCT Filed: Apr. 11, 2024
(86) PCT No.: PCT/JP2024/014640

§ 371 Date: Aug. 18, 2025

(30) Foreign Application Priority Data
Apr. 12, 2023 (JP) 2023-064812
Jan. 26, 2024 (JP) 2024-009960

(51) Int. Cl. G01B 11/02; H04N 1/393; H04N 1/407; H04N 1/409

(52) U.S. Cl. CPC G01B 11/022; H04N 1/393; H04N 1/4076; H04N 1/4092; H04N 1/4097

(57) ABSTRACT

A distance measuring method for measuring a distance between a plurality of points in a main scanning direction based on read waveform data includes a first step of converting the waveform data to a binary waveform binarized based on a predetermined threshold, a second step of comparing the binary waveform with a black-and-white pattern on a distance correction chart to convert, by removing noise from the binary waveform, the binary waveform to edge information including falling edges and rising edges, and a third step of comparing the edge information with physical lengths of the black-and-white pattern on the distance correction chart to derive a number of pixels being light receivers corresponding to a physical interval between black portions of the distance correction chart adjacent to each other in the main scanning direction.

### TECHNICAL FIELD

The present disclosure relates to a distance measuring method.

### BACKGROUND ART

Image reading devices have been widely used for forming erect unity magnification images and are used to measure a distance between selected positions in the main scanning direction of a document. However, such distance measurement is affected by, for example, variations in manufacturing image reading devices, variations in manufacturing rod lens arrays, and thermal expansion in substrates to which light receivers are fixed. Distance measurement with an image reading device thus has limited accuracy when the distance is calculated simply based on a readout waveform, or more specifically, the number of light receivers (the number of pixels) used to read waveforms.

Thus, distance measurement involves corrections to improve accuracy (for example, Patent Literatures 1 and 2). Patent Literature 1 describes a correction method including preparing a calibration chart with black lines arranged at known intervals and reading the chart with an image sensor to perform corrections.

Patent Literature 2 describes a method for correcting the effects of thermal expansion.

### CITATION LIST

### Patent Literature

Patent Literature 1: Unexamined Japanese Patent Application Publication No. 5-172531
Patent Literature 2: International Publication No. 2020/129850

### SUMMARY OF INVENTION

### Technical Problem

The technique described in Patent Literature 1 may cause calibration errors resulting from false detection of the calibration chart due to scratches, missing parts, or stain on the calibration chart.

The technique described in Patent Literature 2 does not reflect the expansion and contraction of the image reading device resulting from thermal expansion in performing corrections.

In response to the above issue, an objective of the present disclosure is to provide a distance measuring method that improves distance measurement accuracy.

### Solution to Problem

A distance measuring method according to an aspect of the present disclosure is a distance measuring method for measuring a distance between a plurality of points in a main scanning direction based on waveform data of a black-and-white pattern on a distance correction chart read by an image reading device including pixels being light receivers arranged in the main scanning direction. The black-and-white pattern includes black portions and white portions arranged at regular intervals in the main scanning direction. The distance correction chart is read with the light receivers arranged in the main scanning direction. The distance measuring method includes a first step of converting the waveform data to a binary waveform binarized based on a predetermined threshold, a second step of comparing the binary waveform with the black-and-white pattern on the distance correction chart to convert, by removing noise from the binary waveform, the binary waveform to edge information including falling edges and rising edges, and a third step of comparing the edge information with physical lengths of the black-and-white pattern of the distance correction chart to derive a number of pixels being the light receivers corresponding to a physical interval between black portions of the distance correction chart adjacent to each other in the main scanning direction.

### Advantageous Effects of Invention

The distance measuring method according to the above aspect of the present disclosure includes converting waveform data acquired by reading the distance correction chart with the image reading device to a binary waveform, and performing corrections based on the results of the comparison between the edge information about the binary waveform and the physical lengths of the black-and-white pattern on the distance correction chart, thus improving accuracy of distance measurement.

### BRIEF DESCRIPTION OF DRAWINGS

FIG. 1 is a perspective view of an image reading device in Embodiment 1;

FIG. 2 is a diagram of the image reading device in Embodiment 1 reading a document;

FIG. 3 is a graph illustrating output waveforms output from the image reading device in Embodiment 1 reading a black-and-white chart;

FIG. 4 is an enlarged view of the graph of the output waveform output from the image reading device in Embodiment 1 reading the black-and-white chart;

FIG. 5 is a side view of the image reading device in Embodiment 1 with a side plate removed;

FIG. 6 is a top view of the image reading device in Embodiment 1, illustrating a reading surface;

FIG. 7 is a diagram of a rod lens array in Embodiment 1;

FIG. 8 is a diagram illustrating image projection performed with the rod lens array in Embodiment 1;

FIG. 9 is a diagram of light receivers arranged on a substrate support plate in Embodiment 1;

FIG. 10 is a perspective view of the image reading device in Embodiment 1 fixed to a fixing jig;

FIG. 11A is a diagram of a distance correction chart placed on a first-pixel side in Embodiment 1;

FIG. 11B is a diagram of the distance correction chart placed on a last-pixel side in Embodiment 1;

FIG. 12 is a top view of the distance correction chart in Embodiment 1;

FIG. 13 is a block diagram of a distance measurement system in Embodiment 1;

FIG. 14 is a flowchart of data processing performed on waveforms of the distance correction chart in Embodiment 1;

FIG. 15A is a flowchart of a noise removal process performed through pattern matching in Embodiment 1;

FIG. 15B is a flowchart of a part of the noise removal process;

FIG. 16 is a graph illustrating an example of waveform processing in the noise removal process;

FIG. 17 is a diagram of a damaged distance correction chart in Embodiment 1;

FIG. 18 is a flowchart of a process for verifying physical lengths and line intervals in Embodiment 1;

FIG. 19 is a diagram illustrating an example of waveform processing in the process for verifying physical lengths and line intervals;

FIG. 20A is a flowchart of a chart position validity process in Embodiment 1;

FIG. 20B is a flowchart of a part of the chart position validity process;

FIG. 21 is a diagram illustrating the relationship between an effective range of reading and an effective range of measurement length correction in Embodiment 1;

FIG. 22 is a diagram illustrating an example of waveform processing in the chart position validity process (first measurement on the first-pixel end);

FIG. 23 is a diagram illustrating an example of waveform processing in the chart position validity process (first measurement on the last-pixel end);

FIG. 24 is a flowchart of a process for combining first measurement and second measurement in Embodiment 1;

FIG. 25 is a diagram describing the process for combining the first measurement and the second measurement;

FIG. 26 is a graph illustrating a change in the device temperature of the image reading device in Embodiment 1;

FIG. 27 is a flowchart of data processing for determining a temperature correction coefficient in Embodiment 1;

FIG. 28 is a graph illustrating displacements in units of pixels in Embodiment 1;

FIG. 29 is a graph illustrating an example measurement of a change in the displacements for every elapsed time in Embodiment 1;

FIG. 30 is a graph illustrating an example measurement of a change in the displacements with respect to the elapsed time in Embodiment 1;

FIG. 31 is a graph illustrating a change in the displacements with respect to temperature.

FIG. 32 is a graph illustrating a change in the slope of the displacements with respect to temperature based on the pixel position;

FIG. 33 is a flowchart of temperature correction using a temperature correction coefficient;

FIG. 34 is a flowchart of data processing performed on a distance correction chart waveform in Embodiment 2 and Embodiment 3;

FIG. 35 is a diagram of a joint between rod lens arrays in Embodiment 3;

FIG. 36 is a diagram of a mount receiving the rod lens array in Embodiment 3;

FIGS. 37A and 37B are diagrams illustrating image forming through the joint between rod lenses 16 in Embodiment 3; and

FIG. 38 is a graph illustrating temperature correction values at the joint between the rod lenses 16 in Embodiment 3;

### DESCRIPTION OF EMBODIMENTS

Embodiments of the present disclosure are described below with reference to the drawings. In the drawings described below, like reference signs denote like or corresponding components, and such components are not described repeatedly.

### Embodiment 1

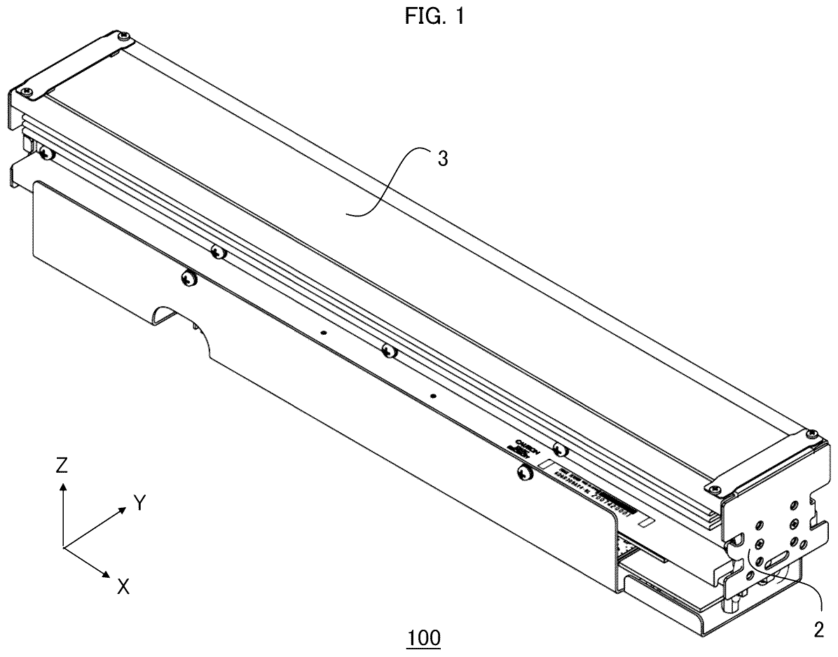

FIG. 1 is a perspective view of an image reading device 100 in Embodiment 1. The image reading device 100 in one or more embodiments of the present disclosure is a contact image sensor (CIS). As illustrated in FIG. 1, the x-direction is a main scanning direction, the y-direction is a sub-scanning direction, and the z-direction is a read depth direction. Side plates 2 are sealing members for reliably preventing dust from entering the image reading device 100. The side plates 2 are typically metal or resin plates. A first transparent member 3 may be formed from, for example, resin or glass, and extends in the x-direction.

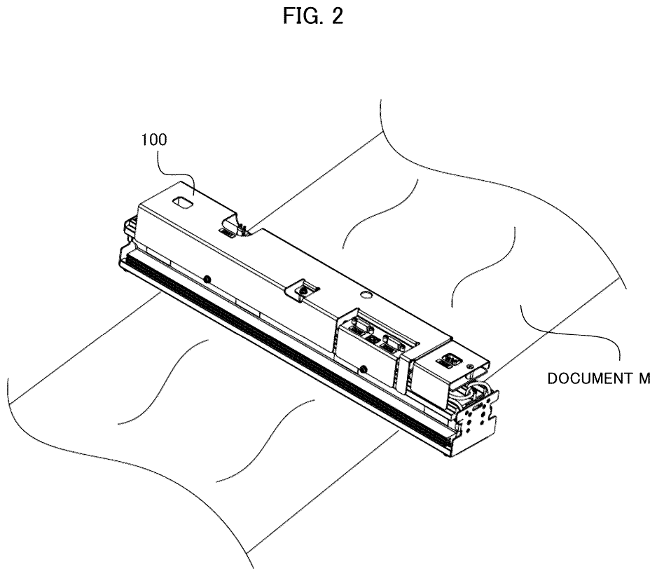

FIG. 2 is a schematic diagram of the image reading device 100 in Embodiment 1 capturing an image of a document M. The document M is, for example, a readable medium (illumination target) carrying image information about banknotes, securities, and other common documents. The image reading device 100 includes a single row of light receivers 15 arranged in the main scanning direction. For capturing an image of a document, the document is to be fed in the sub-scanning direction, or the image reading device 100 is to be moved in the sub-scanning direction.

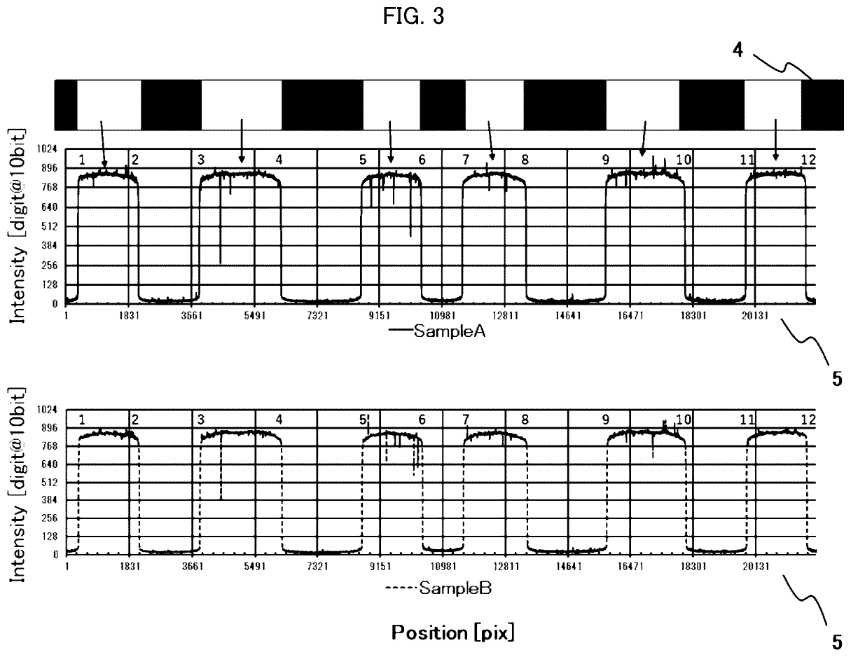

FIG. 3 is a graph illustrating output waveforms 5 output from the image reading device 100 for the document M with, for example, a pattern on a chart 4. The chart 4 includes white portions with a higher output and black portions with a lower output.

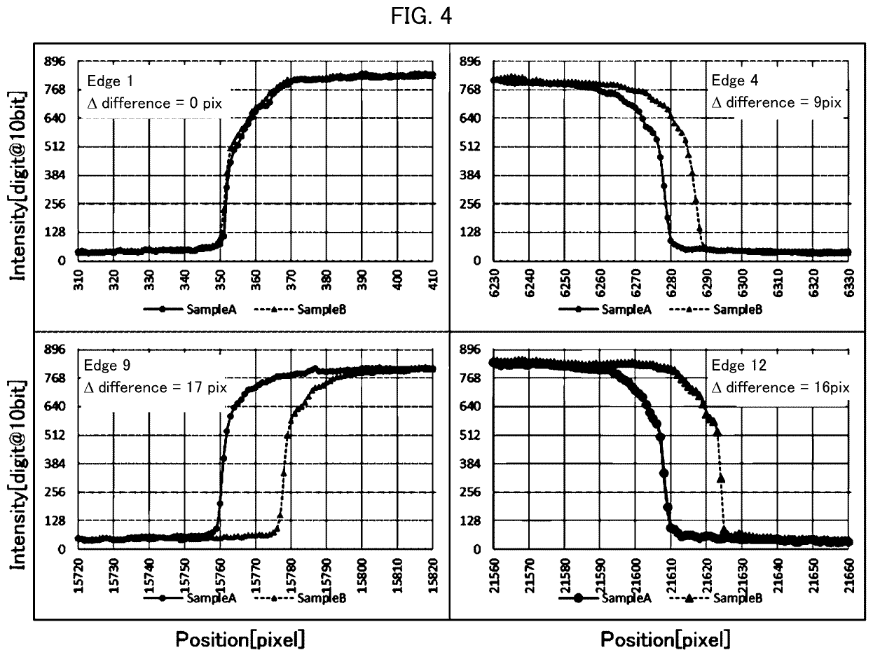

FIG. 4 is a partially enlarged view of the output waveforms 5 output from the image reading device 100. The solid lines and the dotted lines indicate samples of output waveforms from two image reading devices 100. Two waveforms at an edge 12 in a lower right part of FIG. 4 have a larger displacement than two waveforms at an edge 1 in an upper left part of FIG. 4. In other words, the edges may appear at different positions for the image reading devices 100 that have captured images of the same chart 4. To measure the distance between two points using the image reading device 100, for example, the distance can be calculated by multiplying the number of pixels between the points by the size of one pixel (42.33 μm for 600 dpi). However, the number of pixels between the two points may vary from one image reading device 100 to another, causing measurement errors.

Patent Literature 1 describes a solution to a similar issue in a two-dimensional image sensor. Patent Literature 1 describes a correction method including preparing a calibration chart with black lines arranged at known intervals (described later) and reading the chart with an image sensor to perform corrections. However, Patent Literature 1 has no reference to avoidance of calibration errors resulting from false detection due to scratches, missing parts, or stain on the calibration chart.

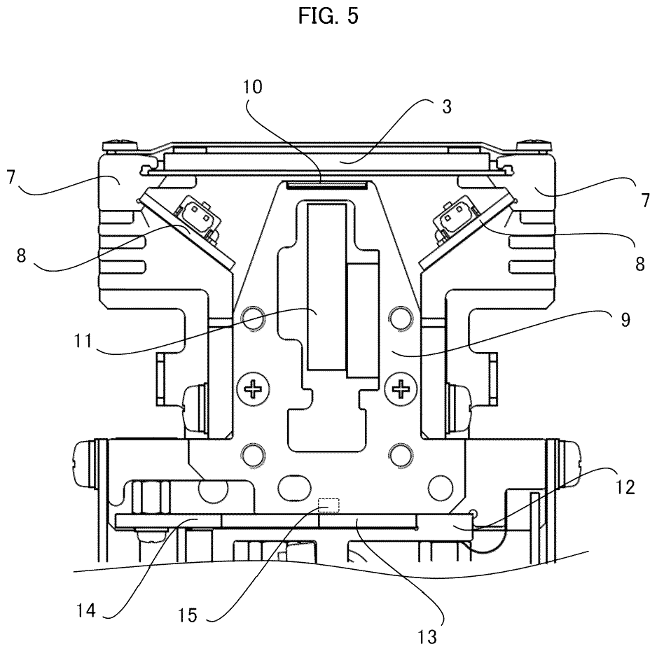

FIG. 5 is a side view of the image reading device 100 with a side plate 2 removed. The first transparent member 3 and light sources 8 are fixed with a second frame 7. A first frame 9 is located inside the second frame 7. The first frame 9 holds a second transparent member 10, a rod lens array 11, the light receivers 15, and other components. The light receivers 15 are fixed to a substrate 13 with an adhesive. A substrate 14 is aligned with the substrate 13 in the sub-scanning direction and fixed to a substrate support plate 12 together with the substrate 13.

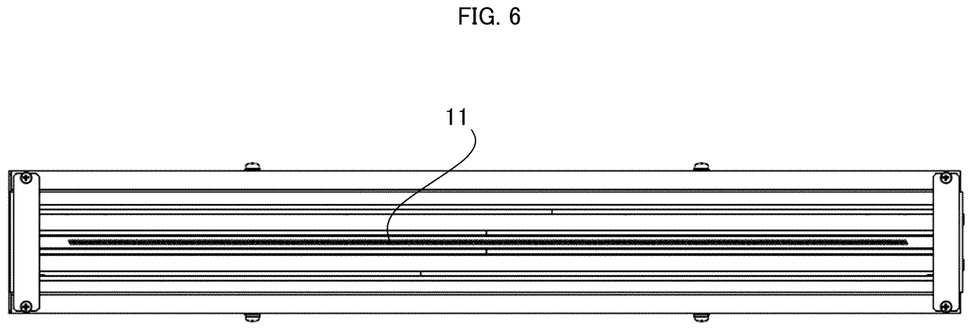

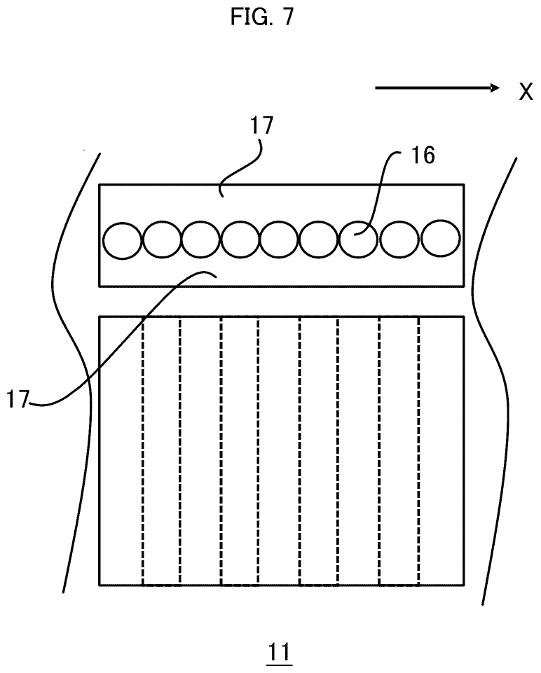

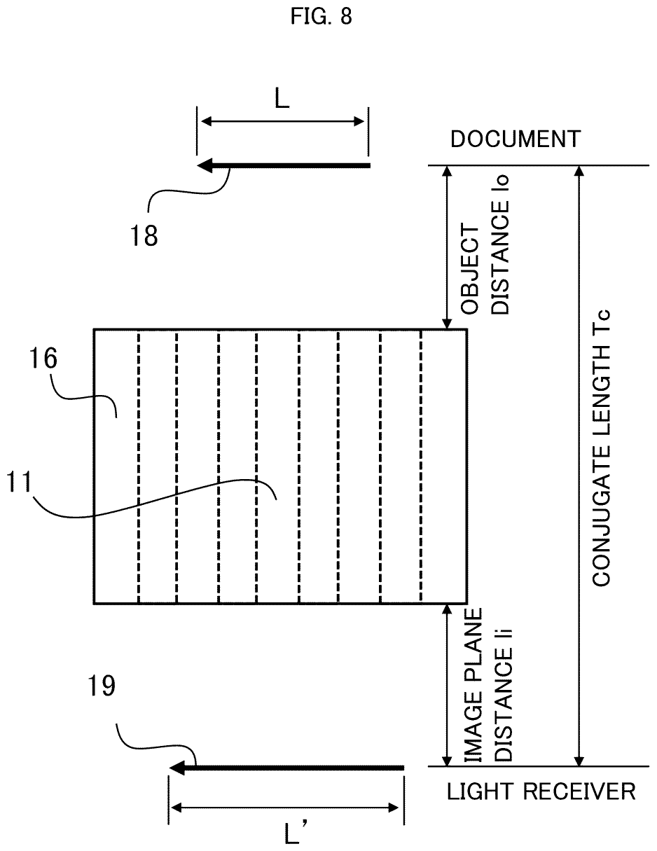

FIG. 6 is a top view of the image reading device 100, illustrating a reading surface. The rod lens array 11 extends in the main scanning direction. FIG. 7 is a schematic diagram of the rod lens array 11. Rod lenses 16 arranged in the main scanning direction are held between fixing side plates 17 and fixed with an adhesive. FIG. 8 is a schematic diagram illustrating image projection of a document read with the rod lens array 11.

A document 18 with a length L is placed at an object distance lo from the rod lens array 11. The rod lens array 11 forms an erect unity magnification image 19 at a distance li. When the object distance lo is equal to the image plane distance li and when the object is apart from the image plane by a conjugate length Tc, each light receiver 15 is at a focal position, allowing the rod lens array 11 to form an image theoretically equal to the size of the document at the position of the light receivers. In other words, when lo=li, the relationship between the document size and the image size is L=L′. However, for the relationship lo=li, L=L′ may not hold precisely due to variations in the manufacturing processes of the rod lenses 11 or variations in the manufacturing processes of the image reading device 100. In other words, the image may be enlarged or reduced relative to the document.

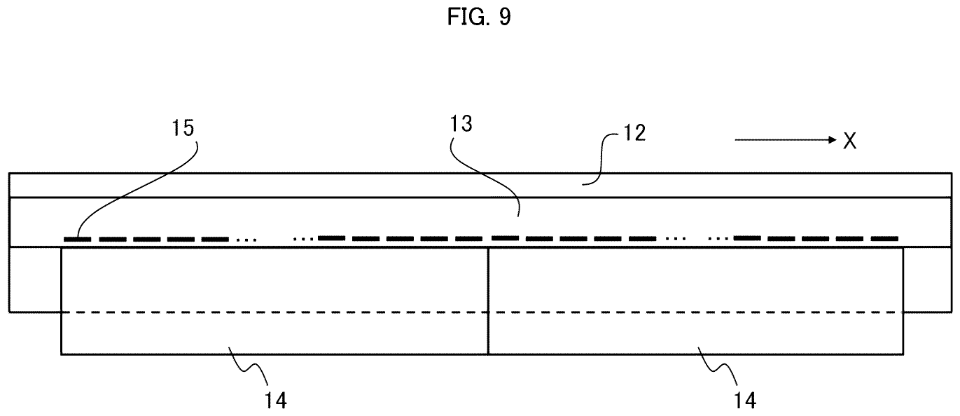

FIG. 9 is a top view of a structure including the light receivers 15, the substrate 13, and the substrate 14 fixed to the substrate support plate 12. FIG. 9 illustrates the structure removed from the first frame 9. The light receivers 15 (pixels) are arranged sequentially in the main scanning direction across the effective reading length. The image reading device 100 starts generating heat and expanding thermally overtime after being powered on. The substrate 13 is one piece of member and undividable in the main scanning direction, and thus also expands thermally. The light receivers 15 are fixed to the substrate 13 with an adhesive. The positions of the light receivers 15 thus also change as the substrate 13 expands thermally. The typical material for the substrate 13 is a glass-reinforced epoxy resin, such as FR-4. The glass-reinforced epoxy resin expands as the temperature rises. Thus, when the image reading device 100 generates heat, fewer pixels are used to read a document with the same size. The image of the document thus appears smaller.

The above issue of the varying number of pixels between selected points due to variations in manufacturing the image reading device 100 or variations in manufacturing the rod lens array 11 can be solved by generating correction data and applying the correction data to the measurement results. A method for generating the correction data is described below.

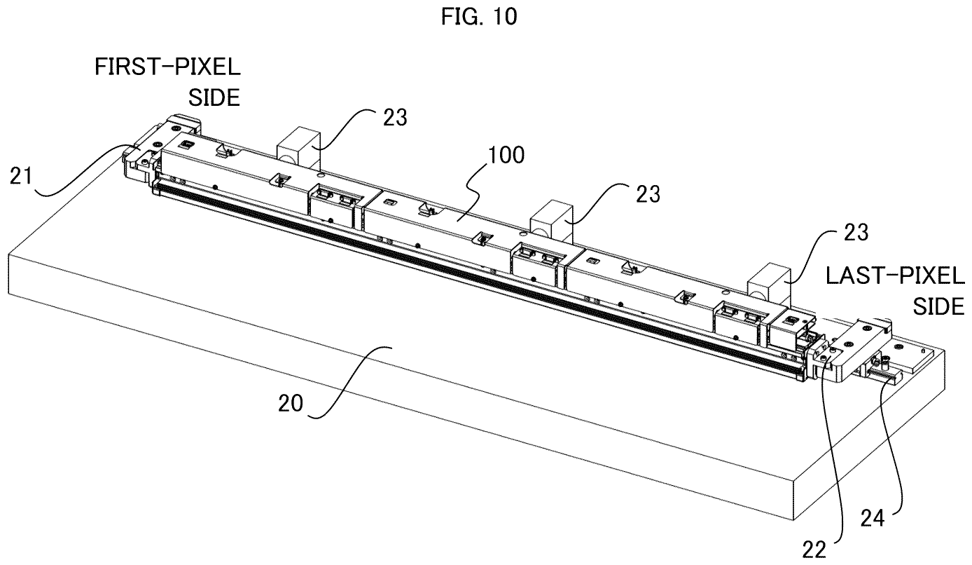

First, the image reading device 100 is to be fastened in an appropriate environment. FIG. 10 illustrates a fixing jig used to acquire distance correction data. The image reading device 100 is fastened to, with fasteners 21 and 22, a table 20 reliably adjusted to be flat. The image reading device 100 is fastened to the table 20 with a rail 24 movable in the main scanning direction. The fastener 21 adjacent to the first-pixel end fastens the image reading device 100 with, for example, a screw. This fastens the image reading device 100 on the first-pixel side during measurement. To acquire the distance correction data, a distance correction chart 25 is placed on the table 20.

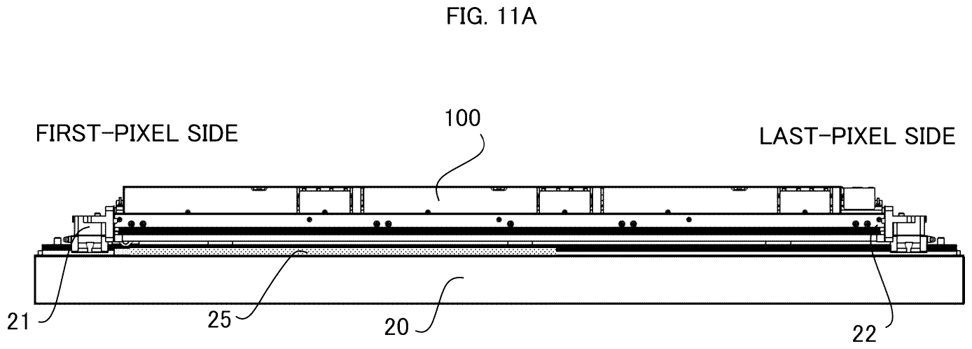

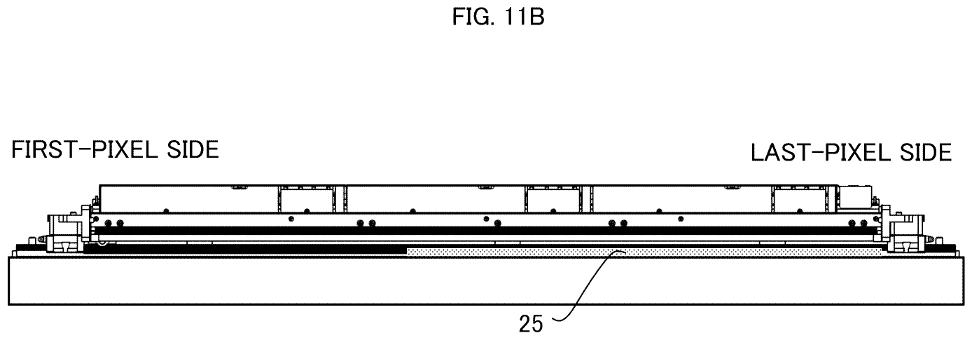

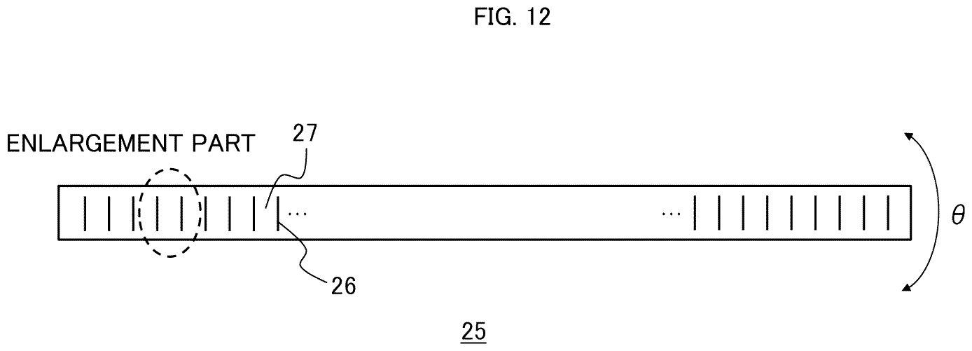

For an image reading device 100 with a long effective reading length, the distance correction chart 25 may be shorter than the effective reading length for reasons associated with chart manufacturing. In this case, the correction data can be acquired separately for the first-pixel side and the last-pixel side of the image reading device 100. The distance correction chart 25 is first placed adjacent to the first-pixel end as illustrated in FIG. 11 to acquire waveform data. The distance correction chart 25 is then placed adjacent to the last-pixel end as illustrated in FIG. 12 to acquire waveform data. The distance correction chart 25 is placed on the table 20 to be parallel to the image reading device 100 to minimize rotation in a 6-direction (A structure for restricting rotation in the 6-direction may be installed on the table 20).

FIG. 12 is a top view of the distance correction chart 25. The distance correction chart 25 includes black lines 26 drawn at regular intervals. The black lines 26 on the chart may have any line thickness and interval. In some embodiments, the black lines 26 may have a thickness of about 200 μm and an interval of about 1 mm. The base material for the distance correction chart 25 may be stainless steel or glass to minimize the effect of thermal expansion caused by a change in the measurement environment (room temperature).

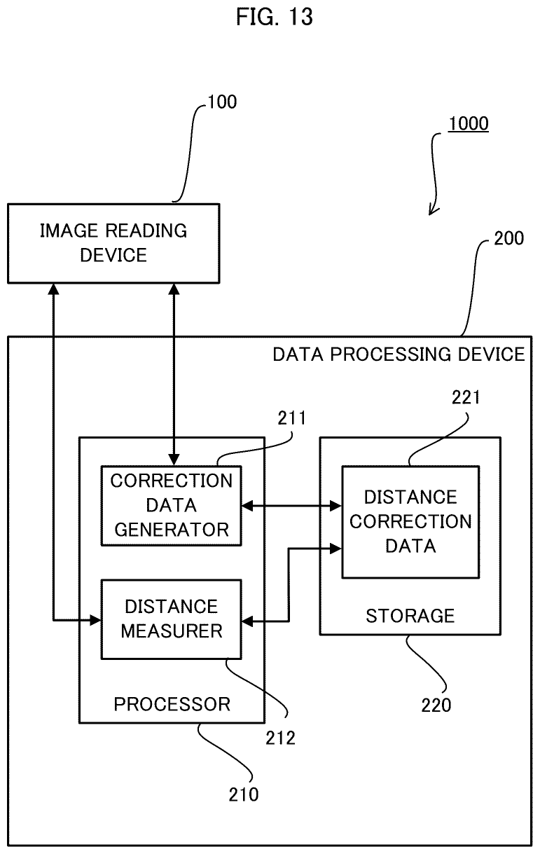

FIG. 13 is a block diagram of a distance measurement system 1000 in the present embodiment. The distance measurement system 1000 reads, as waveform data of a black-and-white pattern, the distance correction chart including the black-and-white pattern including black portions and white portions arranged at regular intervals in the main scanning direction with the light receivers arranged in the main scanning direction of the image reading device 100, performs data processing on the read data, and generates distance correction data. The distance measurement system 1000 further measures a distance between multiple points in the main scanning direction using the distance correction data based on the waveform data acquired by the image reading device 100 capturing an image of a distance measurement target. The distance measurement system 1000 includes the image reading device 100 and a data processing device 200 that measures the distance based on image data read by the image reading device 100.

The data processing device 200 includes a processor 210 and a storage 220. The processor 210 includes, for example, a central processing unit (CPU). The processor 210 executes a program stored in the storage 220 to function as a correction data generator 211 and a distance measurer 212.

The storage 220 includes a random-access memory (RAM) and a nonvolatile memory such as an electrically erasable programmable read-only memory (EEPROM) or a flash memory. The storage 220 stores distance correction data 221 used for distance measurement and various programs executable by the processor 210.

The correction data generator 211 in the processor 210 acquires waveform data acquired by the image reading device 100 reading the distance correction chart 25 and processes the data to generate the distance correction data 221. The correction data 221 is used for distance measurement.

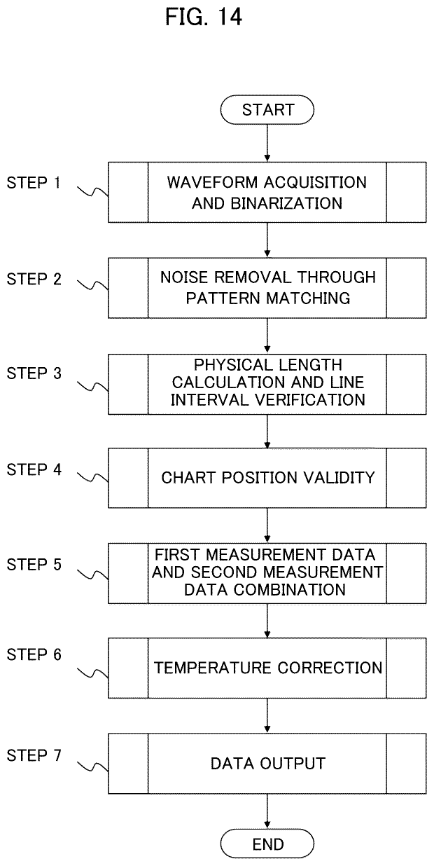

FIG. 14 is a flowchart of data processing performed on the waveform data of the distance correction chart 25 by the correction data generator 211 in the processor 210. The processing is described sequentially below.

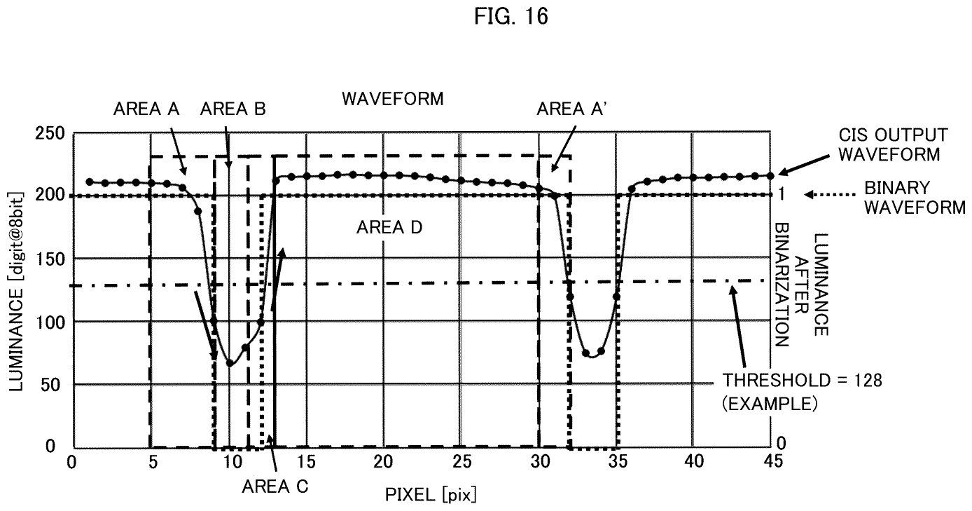

First, the waveform data acquired by the correction data generator 211 in the processor 210 is binarized (step 1 or a first step). The waveform is represented with 0 or 1 separated with a threshold. In FIG. 16, the threshold is set to 128, and the acquired waveform data (solid line) is converted to a binary waveform (dotted line). More specifically, the position at which the pattern changes from white to black on the distance correction chart is defined as a falling position with a value of the binary waveform switching from 1 to 0. The position at which the pattern changes from black to white on the distance correction chart is defined as a rising position with a value of the binary waveform switching from 0 to 1.

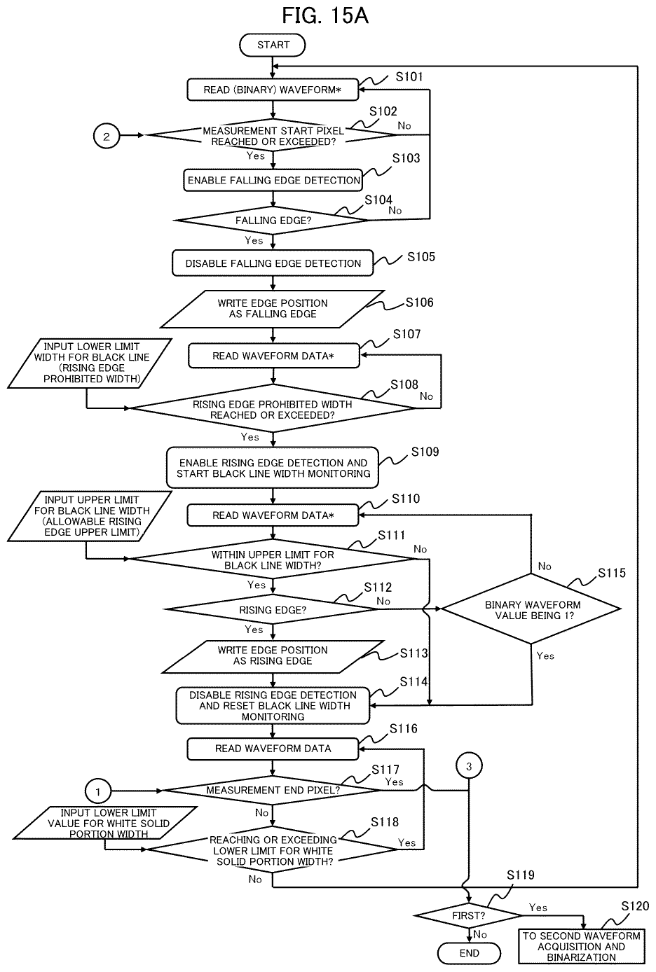

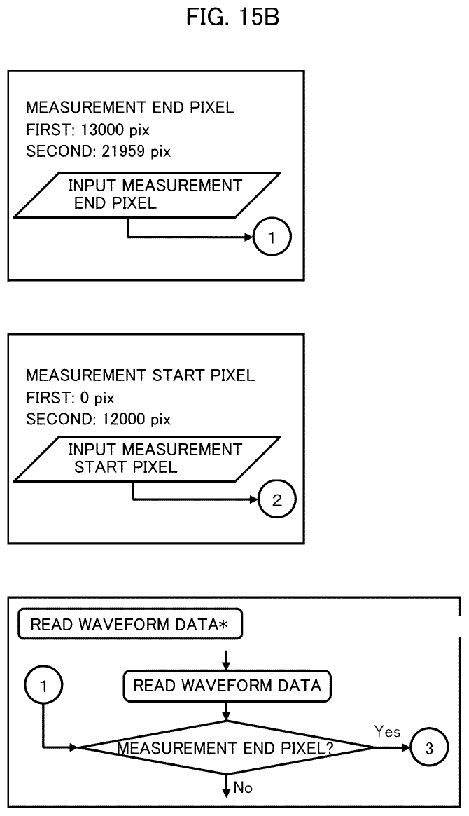

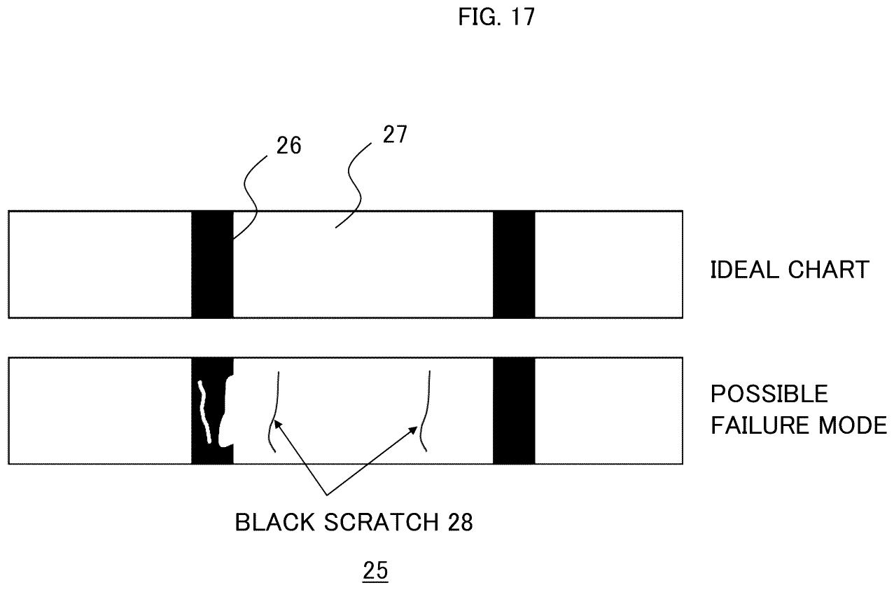

The correction data generator 211 then performs noise removal through pattern matching (step 2 or a second step). More specifically, the correction data generator 211 compares the binary waveform with the black-and-white pattern on the distance correction chart to convert, by removing noise from the binary waveform, the binary waveform to edge information including falling edges and rising edges. FIGS. 15A and 15B are flowcharts of a noise removal process. The distance correction chart 25 to be read has predetermined width for the black portions and white portions. Thus, positions of the next rising edge (the binary waveform switching from 0 to 1) and the falling edge (the binary waveform switching from 1 to 0) are predictable. This process is performed to remove a signal greatly deviating from the predicted position of the next edge to improve the reliability of the distance correction data 221. The situations in a possible failure mode in FIG. 17 that may occur on the distance correction chart 25 possibly lower the reliability of the distance correction data 221. Such situations may be avoided by (i) setting an upper limit and a lower limit for the width of the black line 26 and (ii) limiting the range of a lower limit for the width of a white solid portion 27.

The image reading device 100 first performs scanning in the main scanning direction to cause the correction data generator 211 to read the waveform (step S101). When the scanning reaches or exceeds a predetermined measurement start pixel (Yes in step S102), falling edge detection is enabled to detect a falling edge that is the starting point of a black portion of the black lines 26 in the main scanning direction (step S103 or a 21st step). When a falling edge is detected in an area (area A in FIG. 16) exceeding the measurement start pixel (Yes in step S104), light reception data acquired at pixels subsequent to a pixel at which the falling edge is detected is invalidated to disable the falling edge detection (step S105 or a 22nd step). The correction data generator 211 stores the edge position as a falling edge into the storage 220 (step S106). No rising edge detection is performed until the number of pixels reaches the lower limit for the width of the black line 26. This prevents erroneous detection of white scratches or defects in the black line 26 (area B in FIG. 16). While no rising edge is being detected (No in step S104), the waveform is read repeatedly (step S102).

When the scanning reaches or exceeds, subsequently to the detection of the falling edge, a pixel corresponding to the width (the lower limit for the black line width) for which the rising edge detection is prohibited (Yes in step S108), the scanning enters an area in which the black portion is expected to end (area C in FIG. 16). The correction data generator 211 thus validates the light reception data to enable the rising edge detection and start monitoring the width of the black line (step S109 or a 23rd step). In other words, the rising edge detection is enabled when the scanning reaches an endpoint prediction pixel of the black portion in the main scanning direction. The rising edge detection enabled at the endpoint prediction pixel can prevent erroneous detection of black foreign matter adjacent to the black line, allowing detection of a rounded edge.

The correction data generator 211 further reads the waveform (step S110). When a rising edge is detected as expected (Yes in step S112) in an area within the upper limit for the black line width (Yes in step S111), light reception data acquired at pixels subsequent to a pixel at which the rising edge is detected (area D in FIG. 16) is invalidated (24th step). In other words, the rising edge detection is disabled to reset the monitoring of the black line width (step S114). No rising edge may be detected as expected. In this case, the processing forcibly advances to step S114 when the scanning exceeds the upper limit for the black line width (No in step S111) and exceeds a range corresponding to the endpoint prediction pixel of the black portion in the main scanning direction (24th step). This prevents erroneous detection of black stain or a black scratch on the white solid portion 27 (area D in FIG. 16). The processing returns to step S110 when the value of the binary waveform is 0 (No in step S115) and advances to step S114 when the value of the binary waveform is 1 (Yes in step S115), until the rising edge is detected (No in step S112).

The correction data generator 211 further reads the waveform data (step S116). For a pixel not being a measurement end pixel (No in step S117), the processing returns to step S116 when the lower limit for the white solid portion width is not exceeded (Yes in step S118). When the lower limit for the white solid portion width is exceeded (No in step S118), the scanning enters an area in which a falling edge of a black line 26 is expected to be detected. When the scanning reaches a measurement start pixel of the next black portion in the main scanning direction, the processing returns to step S101 to enable the falling edge detection again (area A′ in FIG. 16). When the waveform reading reaches the measurement end pixel (Yes in step S117), the processing advances to, for the first measurement (Yes in step S119), second acquisition of the waveform and binarization (step S120). For the second measurement (No in step S119), the processing ends. The detected edge information is written, and the processing advances to the next step.

For a distance correction chart with the black line 26 having a width of 211.5 μm and a center interval of 1 mm, the black line 26 has a width of about 5 pixels, and the white solid portion 27 has a width of about 18.5 pixels. For the black line 26 with a lower width limit of 3.5 pixels and an upper width limit of 6.5 pixels, the black line 26 may have erroneous detection for a width of 1.5 pixels. For the white solid portion 27 with a lower width limit of 15.5 pixels, the white solid portion 27 may have erroneous detection for a width of −3 pixels. This may cause errors in distance correction. These ranges are adjustable as appropriate. A smaller range may increase edge detection failure. To compensate for such a disadvantage, data processing is further performed in a physical length and line interval verification process (described later).

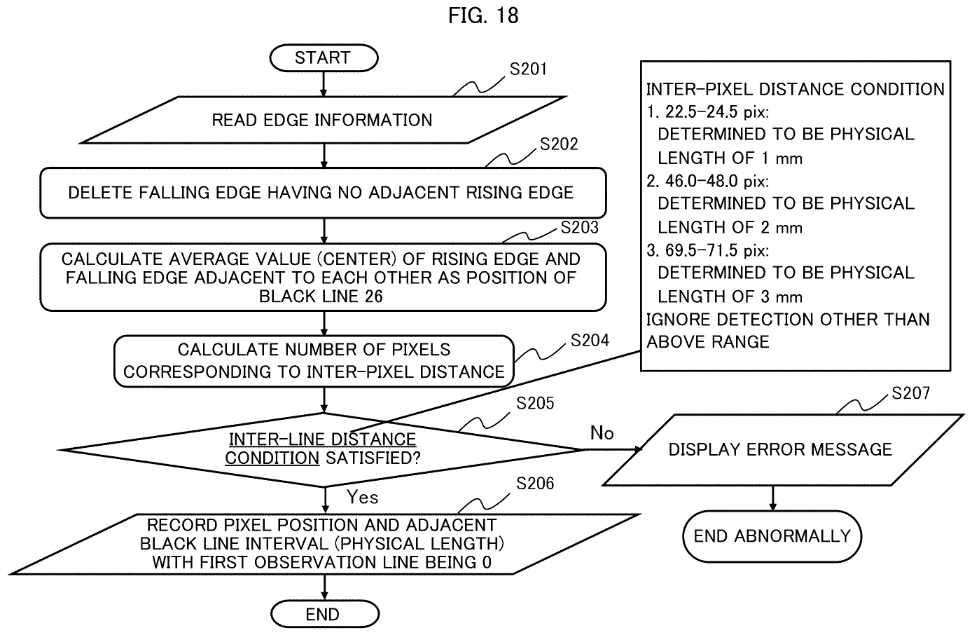

The physical length and line interval verification process is now described (step 3 in FIG. 14 or a third step). This process compares the edge information with the physical lengths of the black-and-whiter pattern of the distance correction chart to derive the number of pixels (the number of light receivers) corresponding to the physical interval between black portions adjacent to each other in the main scanning direction. FIG. 18 is a processing flowchart of this process. The waveform data in this flowchart is converted to edge information through noise removal based on pattern matching. The correction data generator 211 in the processor 210 reads the edge information (step S201) and performs various processes.

First, edge information about a falling edge having no adjacent rising edge is deleted (step S202 or a 31st step). In other words, when no rising edge corresponding to and adjacent to a falling edge is undetected, the falling edge is deleted. When no rising edge is detected through pattern matching, information about the rising edge is missing. This process is performed to retain black lines 26 detected normally alone.

An average position of the pixels at a rising edge and a falling edge adjacent to each other is then calculated, and the resultant value is recorded as the position of the black line 26 (black portion) (step S203 or a 32nd step). More specifically, the position represented by the average value of the positions of a falling detection pixel and a rising detection pixel is defined as the pixel position of the black line 26. The falling detection pixel is a pixel at which a falling edge is detected. The rising detection pixel is a pixel at which a rising edge corresponding to and adjacent to the falling edge is detected.

The processing in step S203 is performed on multiple falling edges and rising edges repeatedly detected in step 2 in FIG. 14 (the flowchart in FIG. 15A) to derive pixel positions of multiple black lines 26 (33rd step). The number of pixels corresponding to the distance between adjacent black lines 26 is then calculated based on the pixel positions of the black lines 26 calculated in step S203 (step S204).

The interval between the pixel positions of the black lines 26 is then compared with the physical interval between the black lines 26 on the distance correction chart 25. When the comparison result indicates that the interval between the pixel positions of the black lines 26 is equal to the physical interval between the black lines 26 on the distance correction chart 25, the number of pixels between the pixel positions of adjacent black lines 26 is determined as the number of pixels corresponding to the physical interval between the black lines 26 on the distance correction chart 25. When the interval between the pixel positions of the multiple black lines 26 is an integer multiple of 2 or greater of the physical interval between the black lines 26 on the distance correction chart, the number of pixels between a pixel position of an interpolated black line 26 and a pixel position of the adjacent black line 26 is determined as the number of pixels corresponding to the physical interval between the black lines 26 on the distance correction chart 25 (34th step). More specifically, the interval between the pixel positions of the multiple black lines 26 being an integer multiple of 1 or greater of the physical interval between the black lines 26 on the distance correction chart 25 is defined as an inter-line distance condition. The number of pixels corresponding to the adjacent black line interval is specifically determined based on whether the interval satisfies the inter-line distance condition (step S205).

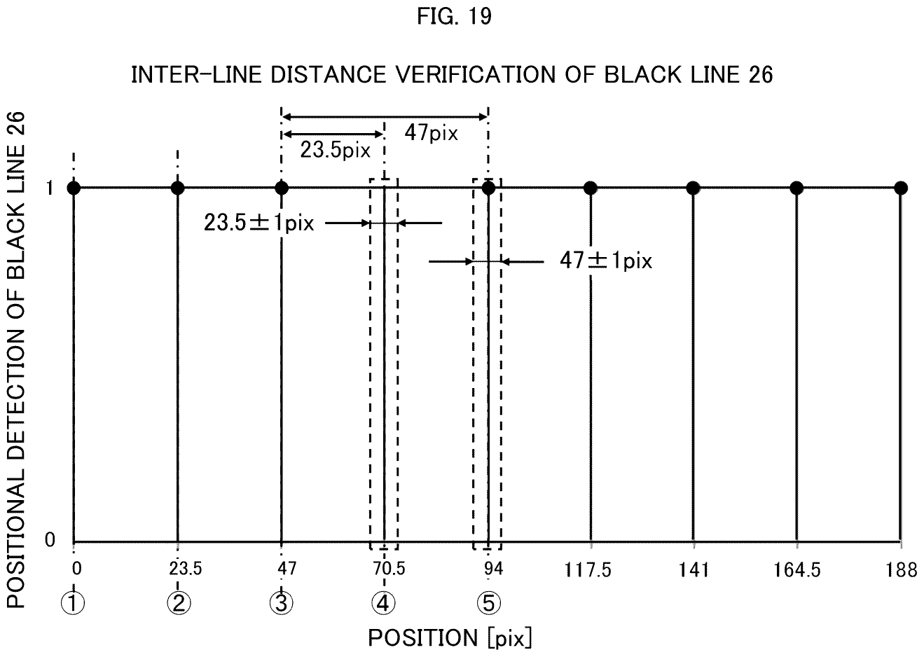

The processing illustrated in FIG. 19 is described in detail using example positions of the black lines 26. A position (circle 1), a position (circle 2), and a position (circle 3) are each at an interval of 23.5 pixels from one another. For an interval of 1 mm between the black lines 26, no black line 26 is missing between the positions. A position (circle 3) and a position (circles 5) are at an interval of 47 pixels from each other. The interval corresponds to 2 mm. A single black line 26 is thus expected to be missing due to an abnormality.

In FIG. 19, the position (circle 1) indicates an encircled 1 in the figure. Similarly, the position (circle 2) indicates an encircled 2 in the figure. The same applies to the position (circle 3) and subsequent positions. In the specification and the drawings, encircled numbers indicate the same.

The interval between the black lines 26 is known. For the interval being 1 mm, the black lines 26 are to be repeated for about every 23.5 pixels. The line interval is thus determined based on the repeated black lines 26. For example, the black line 26 is expected to be at a position (circle 4) next to the position (circle 3) in FIG. 19. When a black line 26 is located within 23.5±1 pixels from the position (circle 3), the black line 26 is detected at an interval of 1 mm. In FIG. 19, however, the position (circle 4) has no position information about the black line 26, and is thus ignored.

The black line 26 is then expected to be located at a position (circle 5). When a black line is located within 47±1 pixels from the position (circle 3), the black line 26 is detected at an interval of 2 mm. In FIG. 19, the black line 26 is at the position (circle 5). The line interval between the position (circle 3) and the position (circle 5) is thus determined to be 2 mm. Similarly, when a black line is located within 70.5±1 pixels from the position (circle 3), the black line 26 is detected at an interval of 3 mm.

In this manner, although the position of the black line 26 is not detected in the previous step, or the noise removal through pattern matching (step 2 in FIG. 14), the data processing is continued when the next black line 26 is detected at the correct position. This indicates that correction data can be continuously generated with the remaining black lines 26 detected correctly under strict conditions set to prevent erroneous detection due to defects or scratches on the black lines 26 or scratches or stain on the white solid portion 27 in noise removal based on pattern matching, with the black lines 26 to be ignored under extra conditions. The expected range of the black lines 26 may be set to any values (The expected range is set to 1 pixel in FIG. 19).

When black scratches 28 on the white solid portion 27 illustrated in, for example, FIG. 17 (an enlarged view of an enlargement part in FIG. 13) are erroneously detected as black lines 26, the next black line 26 is not located within the defined range (23.5±1 pixels, 47±1 pixels, or 70.5±1 pixels), and is thus ignored in this process. This process can thus remove noise that cannot be removed through pattern matching.

The flowchart in FIG. 18 indicates, for example, the state of the two consecutive black lines 26 missing (expected positional range of the black line 26 being 70.5±1 pixels corresponding to an interval of 3 mm between the black lines 26). When three or more consecutive black lines 26 are missing, the inter-line distance condition is not satisfied (No in step S205). An error message appears (step S207) to forcibly end the processing, and remeasurement is prompted.

The number of consecutive missing lines can be set appropriately to prompt remeasurement. When the greatest length measurement error of 0.5 mm is expected for a reading length of 900 mm, for example, the length measurement error of 1.7 μm is expected for a reading length of 3 mm. The light receiver 15 of 600 dpi has a pixel size of 42.3 m. The measurement error is thus sufficiently small (A measurement error smaller than one pixel size is undetectable). The measurement error is sufficiently smaller than the maximum measurement error expected.

The maximum allowable number of missing black lines 26 can be determined based on maximum expected length measurement error or the size of the light receiver 15. When the determination result indicates that the inter-line distance condition determined based on, for example, the allowable number of missing black lines 26 is satisfied (Yes in step S205), the data is recorded in the form of the pixel position-adjacent black line interval (physical length) (step S206). The staring position (0 mm) is a position at which the black line 26 is detected first in each measurement.

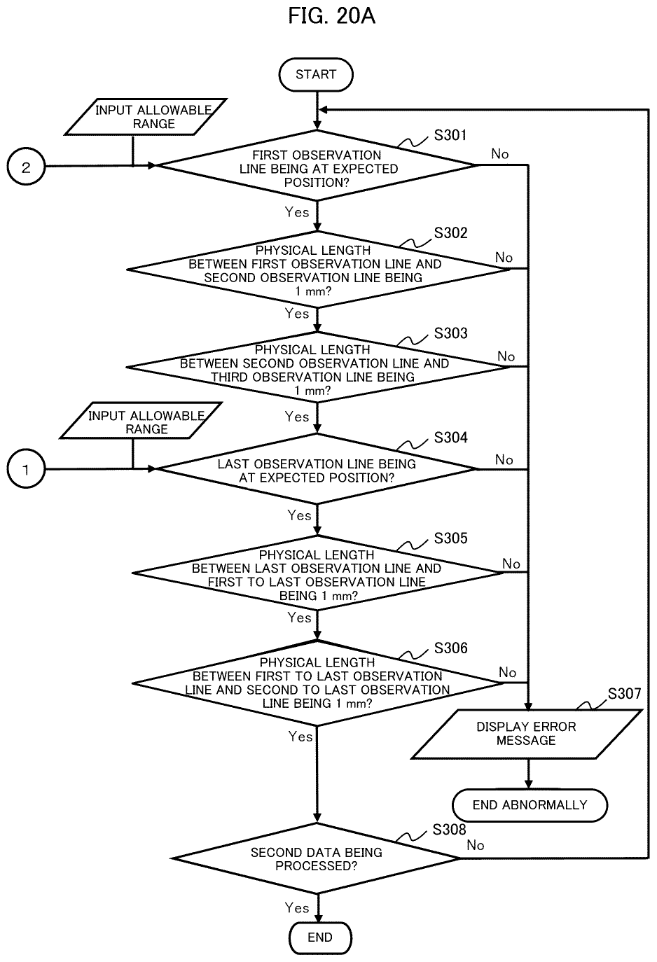

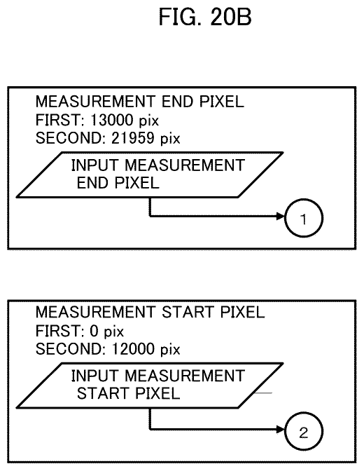

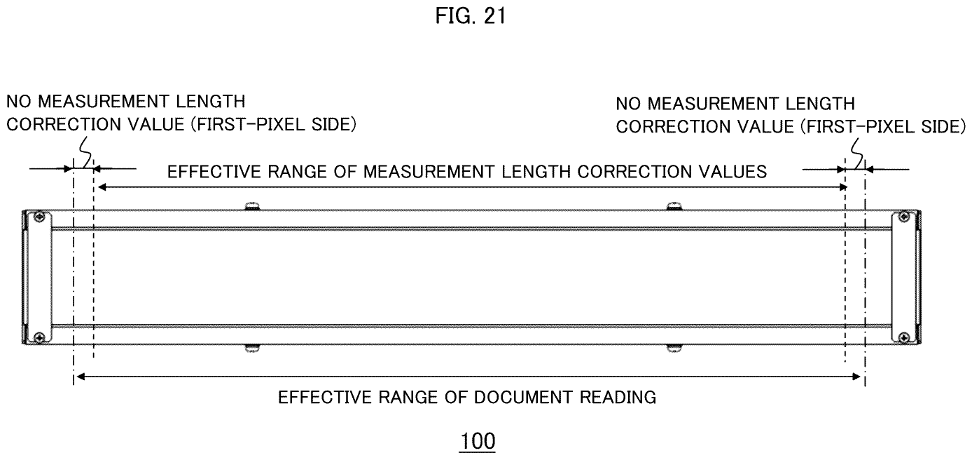

To reliably define the effective range of the length measurement correction, a chart position validity process is performed (step 4 in FIG. 14 or a fourth step). Processing flowcharts are illustrated in FIGS. 20A and 20B. The effective range of document reading for the image reading device 100 and the effective range of measurement length correction values are illustrated in FIG. 21.

The effective range of document reading refers to a range defined from the first pixel position to the last pixel position of the light receivers 15. Correction data is generated based on the waveform data of the distance correction chart 25 imaged by the image reading device 100. The effective range of length measurement correction values is thus narrower than the effective range of document reading. However, the effective range of measurement length correction values is to be clearly defined for a process including distance measurement performed by a customer. The length measurement correction value is generated within a range including the black lines 26 on the distance correction chart 25 alone. To clearly define the effective range of length measurement correction values, the expected position of the black line 26 on the first-pixel side and the expected position of the black line 26 on the last-pixel side are to be determined. Determination is then to be performed as to whether the black lines 26 are actually included in the range. To determine that the black lines 26 are not erroneously detected lines caused by, for example, stain or scratches on the white solid portion and to combine first data and second data (described later), determination is to be performed as to whether the distance correction chart 25 is at an intended position.

More specifically, the correction data generator 211 in the processor 210 determines whether the black portion of the distance correction chart 25 is detected within a predetermined range between the expected position of the black portion on the first-pixel side and the expected position of the black portion on the last-pixel side within the range from the first pixel position to the last pixel position in the main scanning direction.

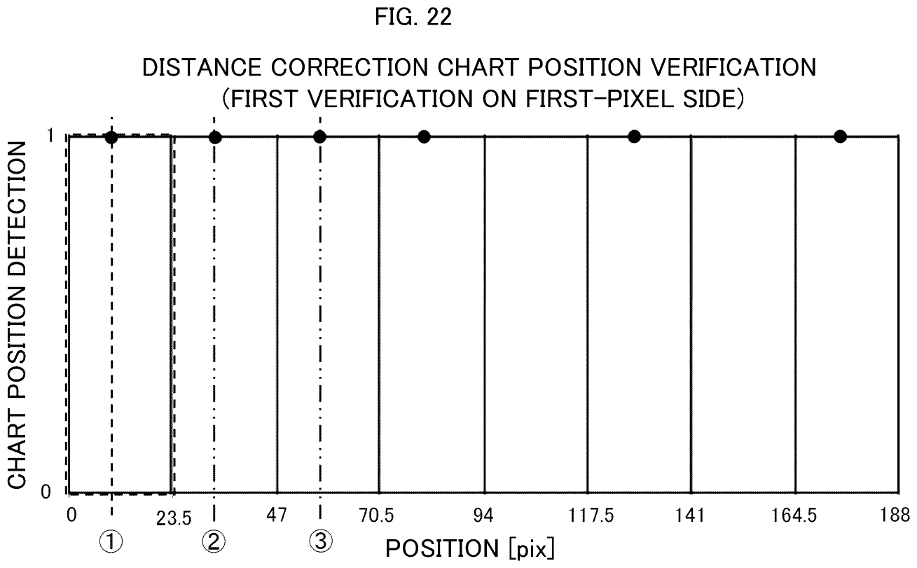

The first measurement (measurement performed on the first-pixel end) is described as an example. FIG. 22 is a diagram illustrating detection of the black lines 26 up to the 188th pixel on the first-pixel side in the first measurement in an example. The black line 26 (circle 1 in FIG. 22) closest to the first-pixel end is at the 16th pixel. The range surrounded by the black dotted line is the expected position range (0 to 23.5 pixels) on the first-pixel end. The determination is performed as to whether the first observation line is within the expected position range (step S301). In the example illustrated in FIG. 22, a black line 26 is actually within the expected position range. When the expected position range is within 23.5 pixels from the first pixel or the last pixel, the effective range of length measurement correction values to be guaranteed is 1 mm inward from the effective range of document reading (about 2 mm shorter than the effective range of document reading).

To determine that the black line 26 (circle 1) in FIG. 22 is not an erroneously detected line and to determine that the data is correctly acquired within the range expected for data combination with the second measurement data, the determination is performed as to whether the distance measurement chart 25 is placed at a correct position during imaging.

FIG. 22 is a diagram illustrating detection of the black lines 26 up to the 188th pixel from the first-pixel end in the first measurement in an example. The position of the black line 26 closest to the first-pixel end (first observation line) is determined to be within the expected position range (Yes in step S301). The second line (circle 2 in FIG. 22) and the third line (circle 3 in FIG. 22) are then determined to be continuous within 23.5±1 pixels (corresponding to 1 mm) (steps S302 and S303). When the three consecutive black lines 26 are detected, the distance correction chart 25 is determined to be placed on at least the first-pixel end. The number of consecutive lines used for determination as to whether the chart is at the correct position may be set to any number.

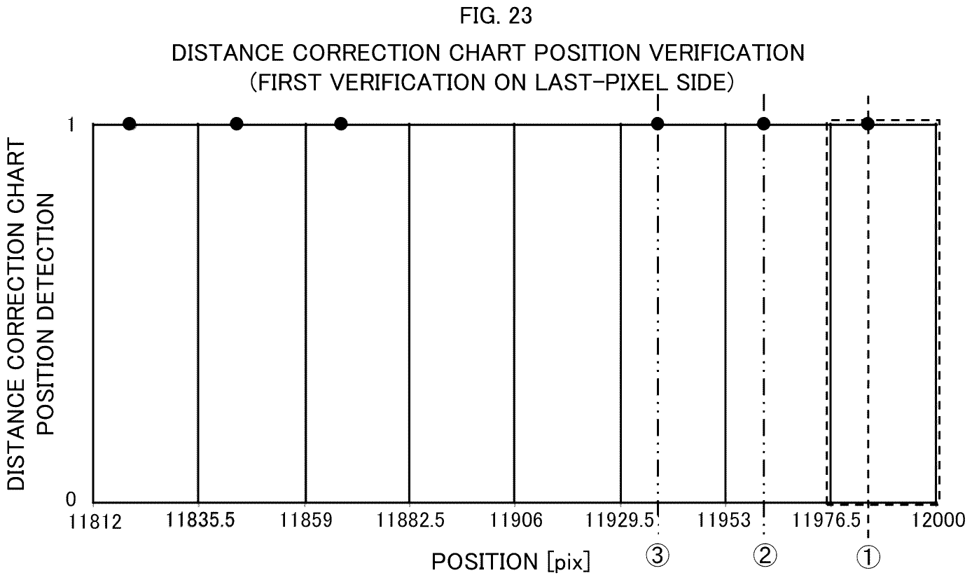

On the last-pixel side as well, the black line 26 closest to the last pixel (last observation line or circle 1 in FIG. 23) is determined to be within the expected position range (a range within 23.5 pixels from the last measurement position of the 12000th pixel in the first measurement and within an area surrounded by a black dotted line frame in FIG. 23) (step S304).

The determination is then performed as to whether an observation line first to the black line closest to the last pixel (circle 2 in FIG. 23) and an observation line second to the black line closest to the last pixel (circle 3 in FIG. 23) are continuous within a range of 23.5±1 pixels (corresponding to 1 mm) (steps S305 and S306). In the example in FIG. 23, the above conditions are satisfied, and the position of the chart on the last-pixel side is appropriate.

Each of the first-pixel side and the last-pixel side is determined as overlapping the distance correction chart 25. The position of the first black line 26 on the first-pixel side and the position of the last black line 26 on the last-pixel side are determined to be within the expected position ranges. Thus, the position of each distance correction chart 25 is determined to be at a correct position with respect to the image reading device 100 in the first measurement (Yes in steps S301 to S306).

When the position of the first black line 26 on the first-pixel side and the position of the last black line 26 on the last-pixel side are not within the expected position ranges (No in steps S301 and S304), an error message appears (step S307), and the processing ends. When each of the intervals between the first observation line and the second observation line, between the second observation line and the third observation line, between the last observation line and first to the last observation line, and between the first to the last observation line and second to the last observation line is not within the range of 23.5±1 pixels (corresponding to 1 mm) (No in steps S302, S303, S305, and S306), the error message appears (step S307), and the processing ends.

When the processing in steps S301 to S306 (No in step S308) is performed on the first data, the processing returns to step S301. The processing in steps S301 to S306 is then performed on the second data to determine whether each distance correction chart 25 is at the correct position. When the processing in steps S301 to S306 is performed on the second data (Yes in step S308), the processing ends.

This processing is complete to determine (guarantee) the effective range of measurement length correction values and allow the first measurement data and the second measurement data to be combined reliably without failure (described later).

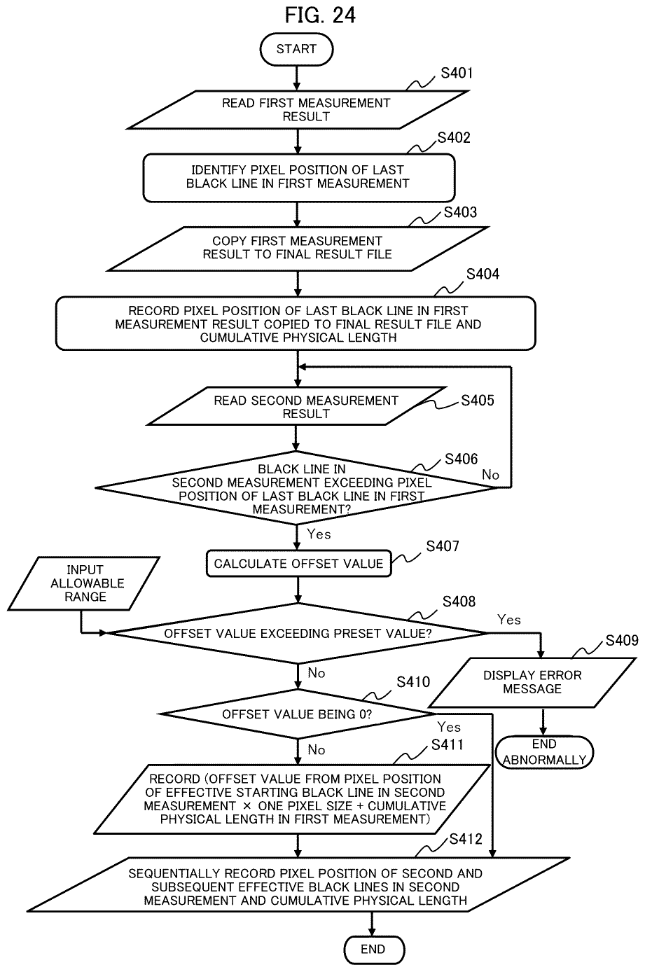

Data pieces each indicating the number of pixels are then combined for multiple distance correction charts 25 arranged in the main scanning direction. The number of pixels corresponds to the physical interval between the black portions of the corresponding one of the multiple distance correction charts 25. For example, the first measurement data and the second measurement data are combined (step 5 in FIG. 14 or a fifth step). A processing flowchart is illustrated in FIG. 24. This processing may be skipped when the image reading device 100 has a short reading length and the distance correction chart 25 is sufficiently longer than the reading length. This structure eliminates divided measurement.

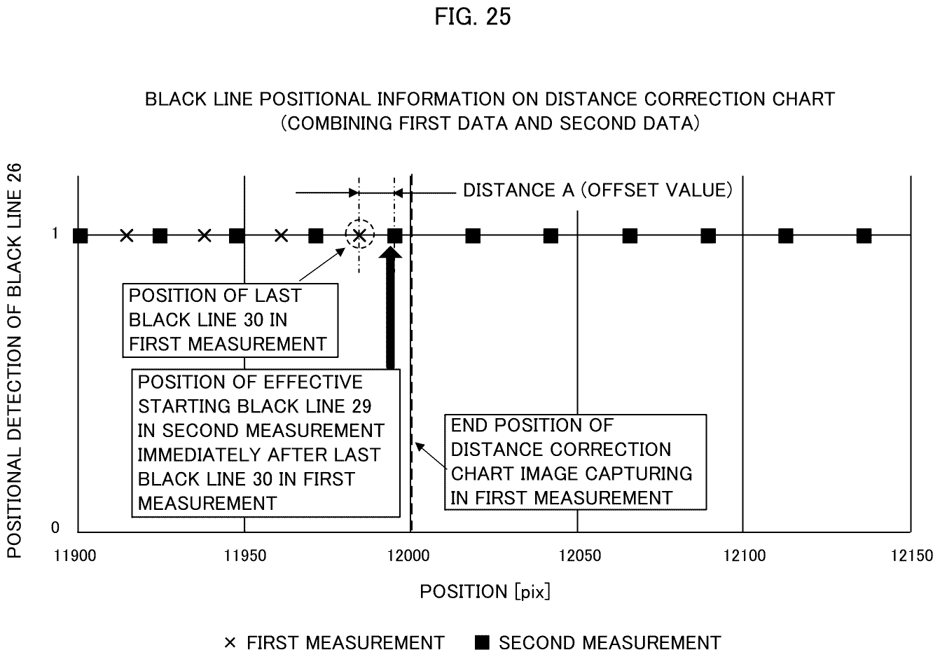

The processing is described with reference to an example of the data processing illustrated in FIG. 25. A first measurement result is read first (step S401). In the example in FIG. 25, an acquisition end position in the first measurement data is set to a 12000th pixel. The pixel position of a last black line 30 in the first measurement is then identified (step S402). The first measurement result is then copied to a final result file (step S403).

A cumulative physical length is then calculated using the adjacent black line interval calculated and recorded in the physical length and line interval verification process (step 3 in FIG. 14). The cumulative physical length is then recorded together with the pixel position of the last black line 30 in the first measurement result copied to the final result file (step S404). The cumulative physical length is calculated by adding the values of the adjacent black line interval up to an intended pixel position.

The second measurement data is then read (step S405). The determination is performed as to whether the black line in the second measurement data exceeds the pixel position of the last black line in the first measurement data (step S406). When a first effective starting black line 29 exceeds the pixel position of the last black line 30 in the first measurement (Yes in step S406), an offset value is calculated (step S407). When the last black line 30 in the first measurement matches a black line in the second measurement in step S406, the processing may advance to step S407. When the black line in the second measurement data does not exceed the pixel position of the last black line 30 in the first measurement data (No in step S406), the second measurement data is read continuously (step S405).

The offset value calculated in step S407 is the value acquired by subtracting, from the pixel position of the effective starting black line 29 in the second measurement data exceeding the last black line 30 first in the first measurement data, the pixel position of the last black line 30 in the first measurement data. When the offset value exceeds a preset value (Yes in step S408), an error message and a message prompting remeasurement appear (step S409), and the processing ends. The offset value may have an upper limit for the accuracy of distance correction. This is because no distance correction data is available between the pixel position of the last black line 30 in the first measurement and the pixel position of the effective starting black line 29 in the second measurement data exceeding the last black line 30 in the first measurement data.

An offset allowable value can be set to any value. The offset allowable value can be set in the same manner as setting an allowable value in the physical length and line interval verification process. When the offset value is within a predetermined allowable value (No in step S408), the processing advances to an operation for actually combining measurement data pieces. The second measurement data is recorded by sequentially adding the second measurement data to the first measurement data as described later.

When the offset value is zero (the last black line 30 in the first measurement fully matches the effective starting black line 29 in the second measurement) (Yes in step S410), the last black line 30 in the first measurement overlaps the effective starting black line 29 in the second measurement. The pixel position of a black line next to the overlapping effective starting black line 29 in the second measurement data and subsequent pixel positions, as well as the corresponding cumulative physical length data are sequentially recorded (step S412). When the offset value is not zero (No in step S410), a distance A is calculated by multiplying the offset value from the pixel position of the first effective starting black line 29 in the second measurement by one pixel size. The resultant distance A is then added to the cumulative physical length of the last black line 30 in the first measurement, and the resultant length is recorded as the cumulative physical length of the effective starting black line 29 in the second measurement (step S411). For the second effective black line and subsequent effective black lines to the last black line in the second measurement, the adjacent black line intervals are then added and recorded, together with the black pixel positions, as the cumulative physical length for the image reading device 100 (step S412). The above processing allows combining data pieces each indicating the number of pixels corresponding to the cumulative physical length that is the physical intervals between the black portions of the corresponding one of the multiple distance correction charts arranged in the main scanning direction.

A data processing method for generating the distance correction data 221 by capturing an image of the distance correction chart 25 with the image reading device 100 has been described above to respond to the issue of the number of pixels between selected points varying due to variations in manufacturing the image reading device 100 or variations in manufacturing the rod lens array 11. The above processing is to be performed on from one image reading device 100 to another for which the distance correction data 221 is to be generated.

A correction method for correcting a measurement error during length measurement is now described. The measurement error results from a change in the position of the light receiver 15 due to thermal expansion when the image reading device 100 is powered on.

Patent Literature 2 describes a method for correcting effects of thermal expansion using a correction chart in a different form. The method focuses on, however, correction for thermal expansion of the calibration plate, and does not focus on expansion or contraction of the image reading device resulting from thermal expansion.

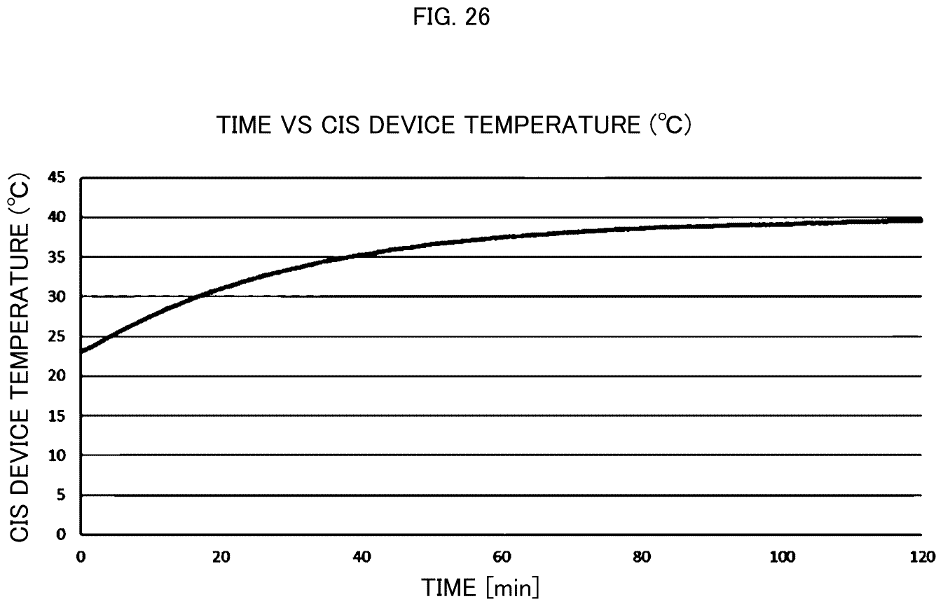

FIG. 26 is a graph indicating the relationship between the time and the temperature of the image reading device 100 (CIS) after the image reading device 100 is powered on. Upon being powered on, the image reading device 100 has a temperature increase. After 120 minutes from the power-on, image reading device 100 enters a thermal equilibrium state with smaller temperature variation. The image reading device 100 is to be incorporated into a device for inspecting scratches or defects on a subject workpiece, thus expected to operate continuously for a long time. Thus, determining the effect of thermal expansion after about 120 minutes from power-on, at which image reading device 100 enters the thermal equilibrium state, is effective.

When acquiring the distance correction data involves waiting time of about 120 minutes, however, the process of acquiring the distance correction data causes a delay in an assembly process of the image reading device 100, increasing the manufacturing cost of the image reading device 100.

The distance correction data is thus acquired at a selected temperature in the assembly process of the image reading device 100. The distance correction data at other temperatures that cannot be measured in the assembly process is estimated using an experimentally predetermined parameter. This allows correction of temperature dependence of the distance correction data without lowering the productivity of the image reading device 100.

A method for experimentally extracting temperature dependence of the distance correction data is described below. A measurement environment used to experimentally extract temperature dependence of the distance correction data is described first. The measurement environment used is illustrated in FIG. 10.

The image reading device 100 is fastened to, with the fasteners 21 and 22, the table 20 reliably adjusted to be flat. The image reading device 100 is fastened to the table 20 with the rail 24 movable in the main scanning direction. The fastener 21 on the first-pixel side fastens the image reading device 100 with, for example, a screw. This fastens the image reading device 100 on the first-pixel side during measurement. The fastener 22 on the last-pixel side allows the image reading device 100 to move in the main scanning direction alone. To acquire the distance correction data, the distance correction chart 25 is placed on the table 20. When the effective reading length of the image reading device 100 is long, the length of the distance correction chart 25 may be shorter than the effective reading length due to chart manufacturing reasons. In this case, the correction data can be acquired separately for the first-pixel side and the last-pixel side of the image reading device 100.

Infrared sensors 23 are located on the table 20 to monitor the temperature of the image reading device 100. The infrared sensors 23 are used to measure the relationship between the time and the temperature for the image reading device 100 after the power-on while the temperature characteristics of the distance correction data are being measured using the distance correction chart 25. Although the infrared sensors 23 are installed at three positions in FIG. 10, the infrared sensors 23 may be installed at any number of positions.

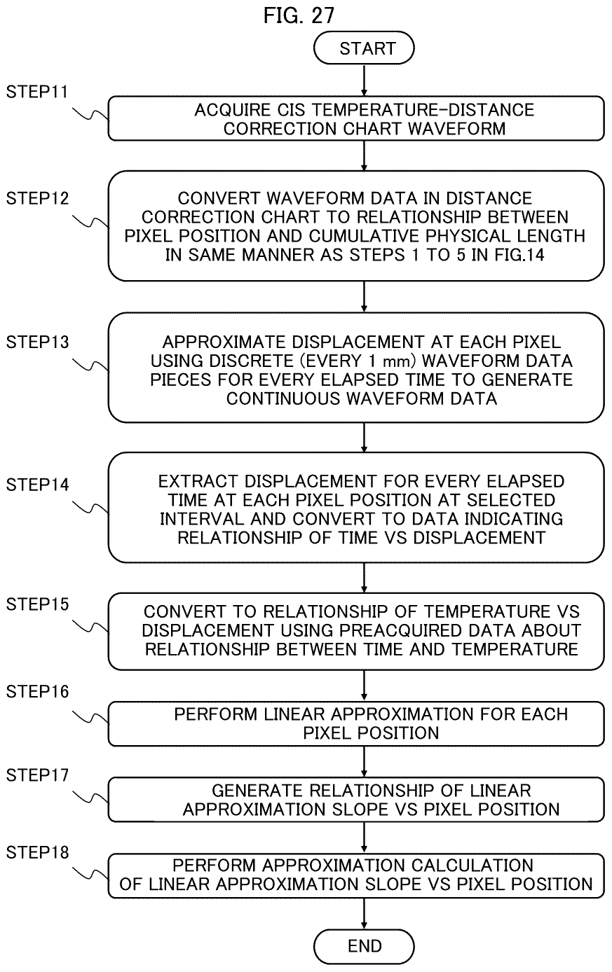

A temperature correction process is described with reference to FIG. 27. FIG. 27 is a flowchart of data processing for determining a temperature correction coefficient. The image reading device 100 is installed first on the table 20 to acquire the temperature characteristics of the image reading device 100. The data processing device 200 acquires a CIS temperature and a distance correction chart waveform using the distance correction chart 25 (step 11).

The correction data generator 211 in the processor 210 then performs, on the distance correction chart acquired in step 11, the same processing as in steps 1 to 5 in FIG. 14, and converts the waveform data of the distance correction chart 25 to the relationship between the pixel position and the cumulative physical length (step S12). More specifically, the processing in steps 13 to 18 in FIG. 27 corresponds to the temperature correction process in step 6 performed after steps 1 to 5 in FIG. 14.

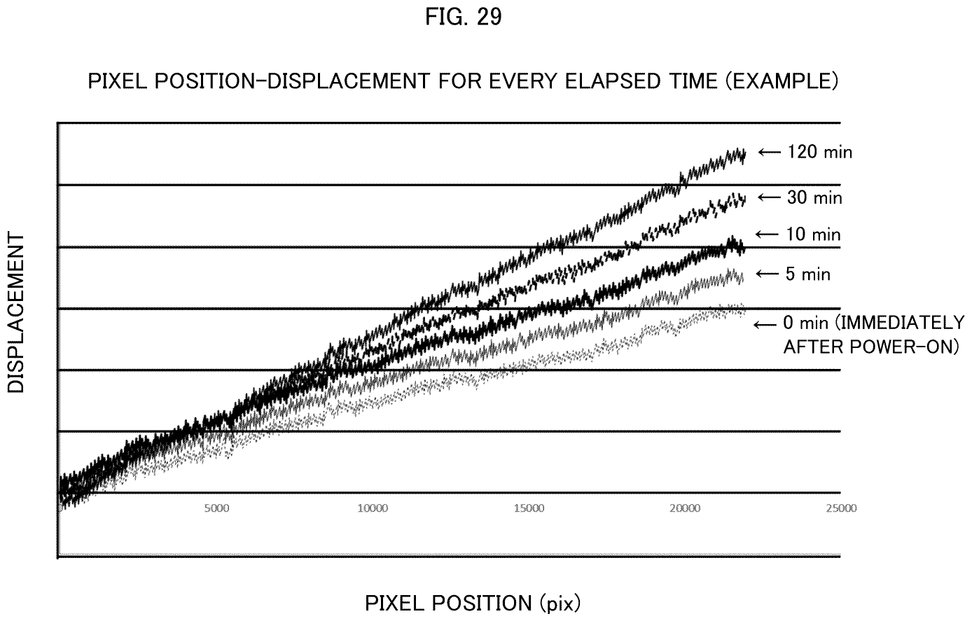

The image acquisition and the conversion to the relationship between the pixel position and the cumulative physical length in steps 1 to 5 in FIG. 14 are to be performed several times, or more specifically, immediately after the power-on, at a time at which the image reading device 100 enters the thermal equilibrium state, and between the power-on and the thermal equilibrium state. Although the data is acquired at 0 (immediately after the power-on), 5, 10, 30, and 120 minutes (thermal equilibrium state) in FIG. 29 (described later), the time at which the data is acquired may be set to any time except 0 minutes (immediately after the power-on) and at the time at which the thermal equilibrium state is achieved. Shorter time intervals can increase the number of data pieces used for the conversion to the time-displacement data in step 14 (described later). This facilitates determination of the temperature correction coefficient in steps 16, 17, and 18.

The correction data generator 211 records the relationship between the pixel position and the cumulative physical length acquired in step S12 together with the elapsed time from the power-on. When the correction data acquisition is divided into two or more times, the data is combined in this step (step 5 in FIG. 14).

The correction data generator 211 then approximates the displacement at each pixel using discrete (every 1 mm) waveform data pieces for every elapsed time to generate continuous waveform data (step 13). The process is described in more detail. The displacement at a pixel position is calculated with a calculation method expressed by Formula 1 below.

$$Displacement = cumulative physical length at the pixel position - the pixel size of one pixel \times ( the pixel position - the pixel position of the first black line 26 ) \qquad ( 1 )$$

For a displacement being a positive value, the imaging result is reduced from the document. For a displacement being a negative value, the imaging result is enlarged from the document. The calculation result is data indicating a value acquired from the pixel position—the displacement at the pixel position. The pixel position herein refers to the position of the black line 26 on the distance correction chart 25. The data indicates the positions of the black lines 26 at every 23.5 pixels (every 1 mm).

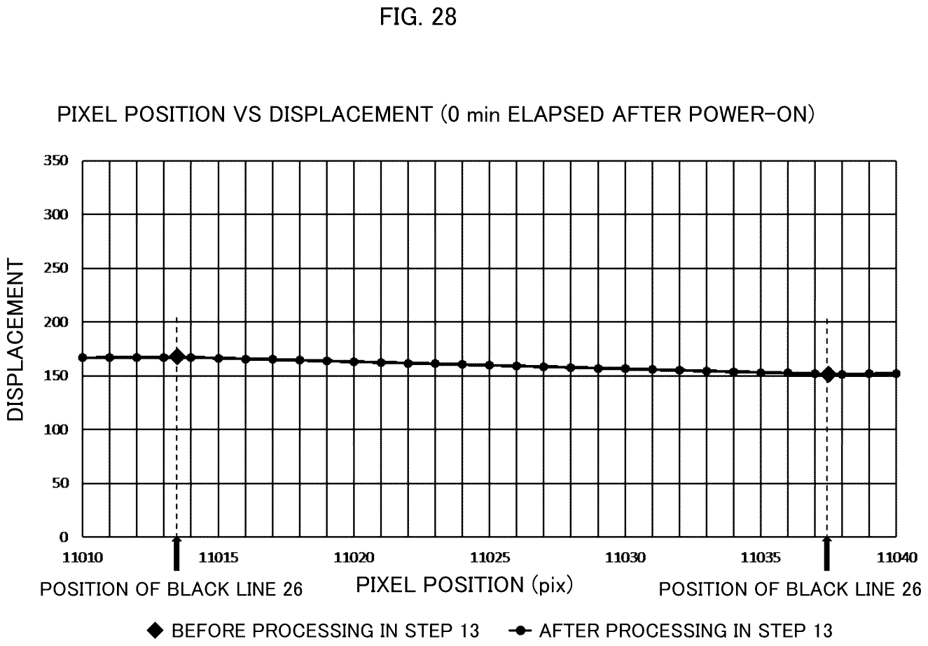

To correct the effect of the temperature in step 13, extracting the displacements at the same pixel position at different temperatures may be difficult when the positional information of the black lines 26 alone is used in step 14 in FIG. 27 (described later). The correction data generator 211 thus calculates the displacements of pixel positions other than the pixel positions at which the black lines 26 are recorded, and continuously records the displacements of all the pixels in the image reading device 100. FIG. 28 is a graph illustrating example calculation results of the displacements in units of pixels. Data pieces indicating the black lines 26 are at a 11013.5th pixel and a 11037.5th pixel. No data pieces indicating the black lines 26 are at pixel positions between the two pixels. For the pixel positions between the above two pixels, the processor 210 approximates the displacements using linear approximation based on the recorded displacements at the positions of the black lines 26. Data pieces each indicating an approximate value of the displacement of the corresponding pixel are recorded. In this manner, the relationship between the pixel positions and the displacements for every elapsed time is recorded for the image reading device 100. FIG. 29 is a graph illustrating an example measurement of a change in the displacements for every elapsed time.

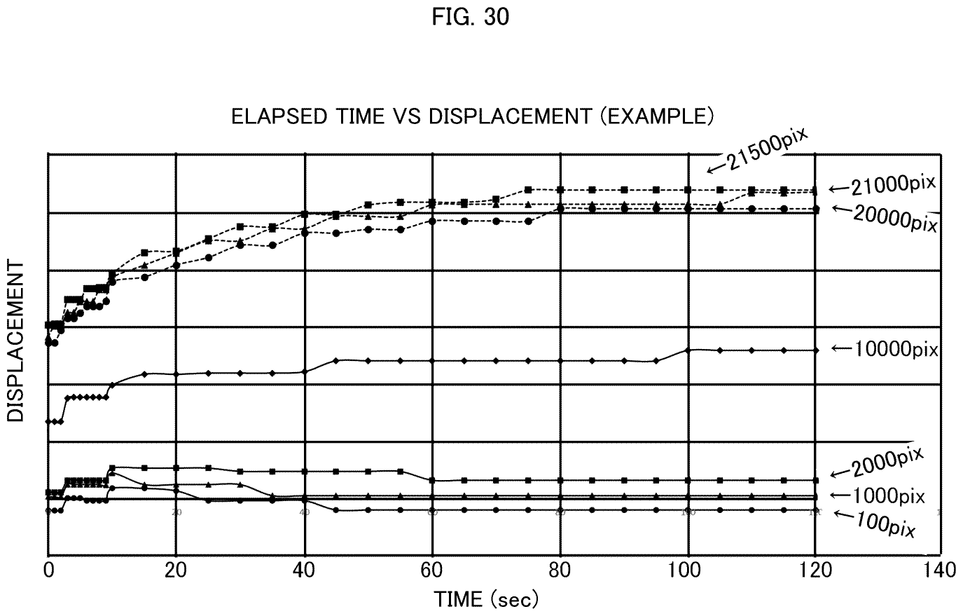

The correction data generator 211 then determines, based on the relationship between the pixel positions and the displacements acquired in step 13, the displacements for every elapsed time at each pixel position at a selected interval (for example, a 1000 pix interval), and generates data indicating the relationship between the elapsed time and the displacements (step 14). More specifically, the data indicating the pixel position-displacement is converted to data indicating the displacement at the elapsed time at the same pixel position. FIG. 30 is a graph illustrating an example measurement of a change in the displacements with respect to the elapsed time.

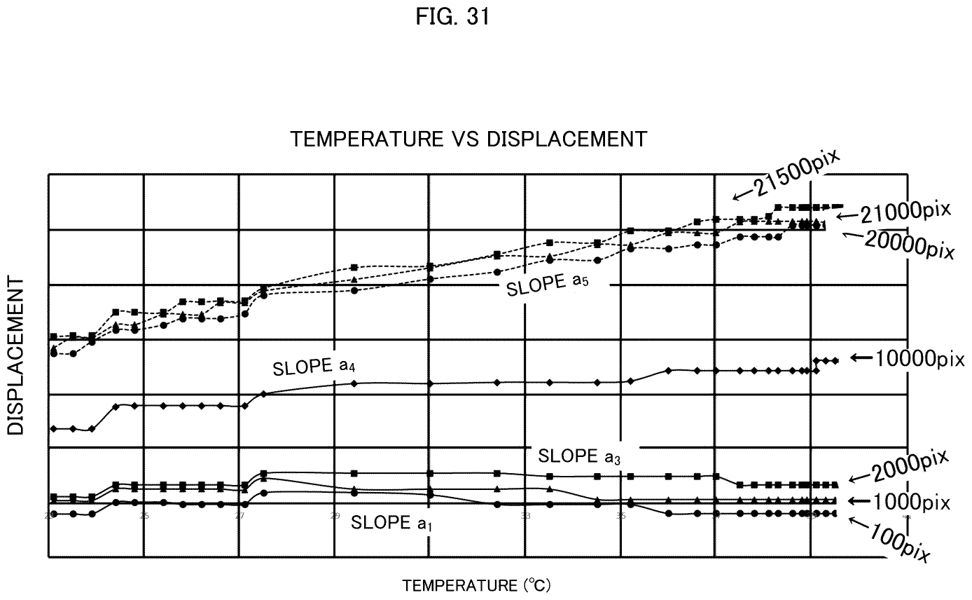

In the example in FIG. 30, the displacements at 100th, 1000th, 2000th, 10000th, 20000th, 21000th, and 21500th pixels are extracted from the data in FIG. 29. As more pixel positions are extracted, an approximation process (described later) is performed with higher accuracy. The data is thus to be extracted at as many pixel positions as possible, although the data may be extracted at any frequency. The horizontal axis is converted to time. The correction data generator 211 uses the relationship between the elapsed time from the power-on of the image reading device 100 and the device temperature acquired by the infrared sensors 23 to convert the data acquired in step 14 to the relationship between the device temperature of the image reading device 100 and the displacements (step 15). More specifically, the correction data generator 211 determines a change in the displacements with respect to the temperature illustrated in FIG. 31 based on the relationship between the elapsed time and the temperature in FIG. 26 and the relationship between the elapsed time and the displacements in FIG. 30.

After calculating the relationship in FIG. 31, the correction data generator 211 then performs linear approximation using least squares for each pixel position (step 16). The linear expansion is defined by Formula 2 below.

$$Linear expansion ( change in displacements ) Δ L = α \times L \times Δ T \qquad ( 2 )$$

In the above formula, α is a linear expansion coefficient, L is a pixel position from the first pixel, and ΔT is a temperature difference.

The linear expansion coefficient α is a value determined based on the material. However, the image reading device 100 includes various assembled components. The linear expansion coefficient α is thus difficult to estimate. The relationship between the temperature and the displacements can be linearly approximated based on the linear expansion formula when L is substantially a constant. For the graph in FIG. 31, the displacement is expressed by Formula 3 below when linear approximation is performed using, for example, the least squares. In Formula 3, b is a temperature-independent term. More specifically, b can be ignored when the amount of change in the displacement is determined.

$$( Displacement ) = a \times ( temperature ) + b \qquad ( 3 )$$

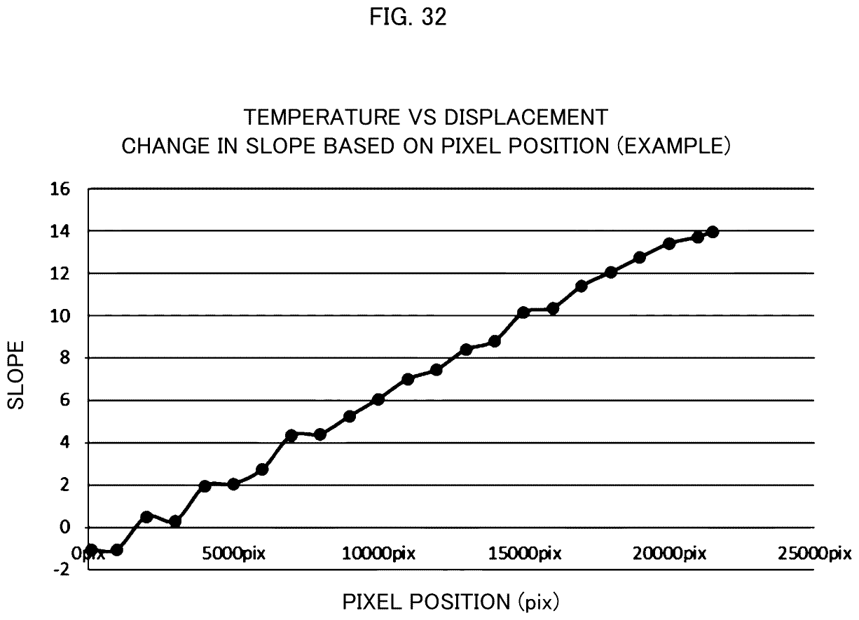

FIG. 31 is a graph illustrating lines for the respective pixel positions L corresponding to the distance from the start point (pixel position) of the distance correction data. Thus, the pixel position L may be substantially constant for each line representing the displacement at each pixel position L. The lines for the respective pixel positions L in FIG. 31 indicate that the displacement changes as the temperature changes. The slope a acquired through linear approximation in the temperature range indicated in the graph in FIG. 31 is larger at a distance farther from the start point (pixel position) of the distance correction data. This indicates that, at the same temperature T, the displacement increases as the pixel position L increases. Although the linear expansion coefficient α is typically temperature-dependent, the image reading device 100 has ΔT of about 20° C. at most as illustrated in FIG. 26 under an operating environment at room temperature (about 24° C.). The linear expansion coefficient α can thus be substantially constant. The slope a in Formula 3 through linear approximation on the change in the displacements with respect to the temperature change thus corresponds to α×L in Formula 2 for linear expansion ΔL. The pixel position L alone can thus be used as a variable. The correction data generator 211 extracts the slope a (a1, a2, a3, . . . , a7) of the linear approximation result at each pixel position L to generate the relationship between the pixel position and the slope a illustrated in FIG. 32 (step S17). FIG. 32 is a graph illustrating a change in the slope a of the displacement with respect to the temperature based on the pixel position.

The slope a linearly responds to the pixel position L. The correction data generator 211 thus performs linear approximation again using least squares for the line (step S18). Linear approximation yields Formula 4 below.

$$( Slope ) a = c \times ( pixel position from first pixel ) + d \qquad ( 4 )$$

The displacement is expressed by Formula 5 below. In Formula 5, b is a temperature-independent term. More specifically, b can be ignored when the amount of change in the displacement is determined.

(Displacement)=(c×(pixel position from first pixel)+d)×(temperature)+b (5)

The information to be used is the change in the displacement ΔL for the image reading device 100 at a device temperature Tcis. The change in the displacement ΔL is calculated based on a displacement L′ measured at a device temperature T′ of the image reading device 100 measured in the production line. The value ΔL is calculated using Formula 6 below.

$$Change in displacement Δ L = ( c \times ( pixel position from first pixel ) + d ) \times ( Tcis - {T}^{′} ) \qquad ( 6 )$$

In Formula 6 above, c and d are terms associated with the linear expansion coefficients to be experimentally predetermined based on the graph illustrated in FIG. 32. The values c and d are temperature correction coefficients. The values c and d are constant unless the combination of the materials or the components is changed. The values may thus be experimentally predetermined for each model.

The change in the displacements can be calculated using Formula 6 when a target pixel position for the displacement calculation is determined by monitoring Tcis. The value Tcis may not be monitored when the image reading device 100 is preheated upon activation to be operated in the thermal equilibrium state (the temperature at which the image reading device 100 is in the thermal equilibrium state is to be determined). The value T′ is the device temperature of the image reading device 100 measured in the production line. The temperature may be recorded in the storage 220 in the image reading device 100.

A cumulative physical length reflecting the temperature dependence at a selected pixel position is Ptemp expressed by Formula 7 below when the image reading device 100 has a device temperature of Tcis. In the formula, P is a cumulative physical length at the pixel position.

$$Ptemp = {P}^{′} + Δ L \qquad ( 7 )$$

In Formula 7, P′ and ΔL depend on the pixel position from the first pixel, and thus the pixel position at which the displacement is to be determined can be used for the calculation. The value ΔL also depends on Tcis. Thus, the pixel position and Tcis are substituted into Formula 6 to calculate ΔL. In this manner, the temperature correction coefficient in Formula 6 can be used to correct the temperature effect without measuring the temperature dependence of the displacement for every image reading device 100.

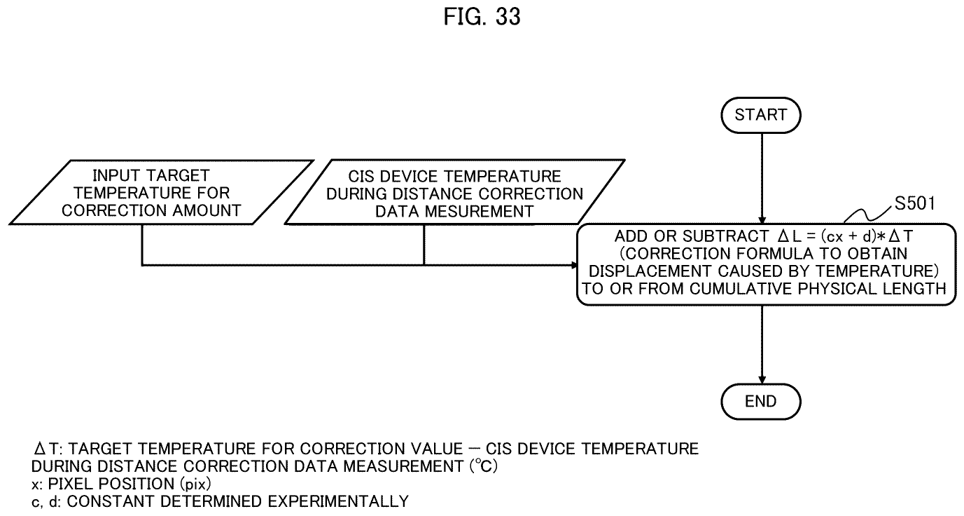

FIG. 33 is a flowchart of the temperature correction process (step 6 in FIG. 14) using a temperature correction coefficient. More specifically, FIG. 33 describes a processing method for applying, based on the data about the change in the displacements with respect to the temperature derived through the process illustrated in the flowchart in FIG. 27, the correction of the displacements resulting from linear expansion to the relationship between the pixel positions and the cumulative physical lengths derived in steps 1 to 5 in FIG. 14.

As described above, the change in the displacement depends on the pixel position. In the temperature correction process illustrated in FIG. 33, the temperature of the image reading device 100 during the distance correction data measurement, a target temperature at which the temperature correction is to be performed, and the device temperature of the image reading device 100 (CIS) during the distance correction data measurement are to be acquired first. The temperature during the distance correction data measurement is pre-recorded in the storage 220 in the data processing device 200. The correction data generator 211 in the processor 210 then adds or subtracts the displacement ΔL calculated using Formula 6 above to or from the cumulative physical length (step S501), and ends the process. This process allows temperature correction to be performed on the number of pixels corresponding to the cumulative physical length that is the physical intervals between the black portions of the distance correction chart. When the temperature correction process is not to be performed, step 6 in FIG. 14 can be skipped.

In the flowchart in FIG. 14, the correction data generator 211 in the processor 210 finally performs a data output process (step 7 in FIG. 14). This process is performed in the data format of pixel position-cumulative physical length in steps 1 to 6. When the processing in step 7 is skipped, data in the format output after the processing in step 6 is directly used as the distance correction data 221. However, the pixel positions recorded in the distance correction data 221 are values for every interval of the black lines 26 on the distance correction chart 25. The cumulative physical lengths are not recorded for all the pixel positions, possibly being inconvenient. In this case, the data can be converted to continuous data through conversion from the cumulative physical lengths to the displacements and approximation of pixels between adjacent lines performed in step 13 in FIG. 27. In this manner, the correction data generator 211 in the data processing device 200 converts data to data in a format convenient to the end user of the image reading device 100, and outputs the data (step 7 in FIG. 14).

The distance measurer 212 in the data processing device 200 measures a distance between multiple points in the main scanning direction based on the waveform data acquired by reading the measurement target image with the image reading device 100 and using the distance correction data 221 generated through the processing in the flowchart in FIG. 14.

### Embodiment 2

Embodiment 2 of the present disclosure is described with reference to the drawings.

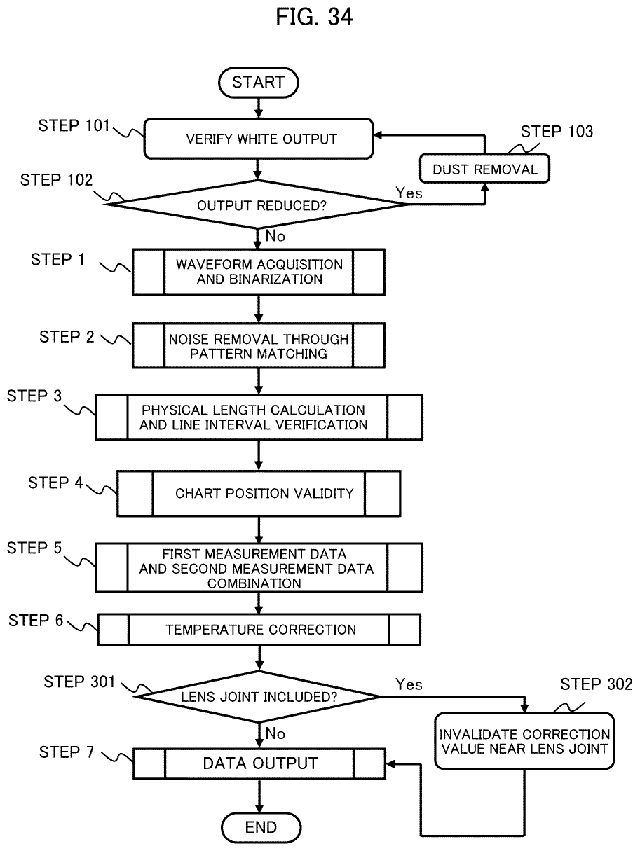

FIG. 34 is a flowchart of processing a distance correction chart waveform in Embodiment 2.

The processing flowchart in FIG. 34 includes a white output verification step (step 101), an output reduction verification step for verifying output reduction caused by foreign matter such as dust (step 102), and a dust removal step (step 103) before the waveform acquisition and binarization process (step 1) in the flowchart in FIG. 14.

In Embodiment 1, the data processing device 200 generates the distance correction data 221 for correcting the physical length of the image reading device 100 in the main scanning direction based on the output data from the image reading device 100 that has read the black-and-white pattern including black portions and white portions arranged at equal intervals in the main scanning direction on the distance correction chart 25. However, when the distance correction chart 25 is read with stain or foreign matter on the surface of the first transparent member 3, such stain or foreign matter on the surface of the first transparent member 3 may be misidentified as the black lines 26 on the distance correction chart 25.

In Embodiment 2, the white output verification step (step 101) is performed before the waveform acquisition and binarization process (step 1). In this step, a white chart for white luminance correction (for received-light amount correction of the light receiver 15) is read in advance with the image reading device 100 to verify the white output (white correction process).

When the surface of the first transparent member 3 has stain or foreign matter, the light receiver 15 at the position receives less light. Thus, the state of the surface of the first transparent member 3 is determined in the output reduction verification step for verifying output reduction caused by foreign matter such as dust (step 102). When data from a light receiver 15 indicates a decrease in received light (light reception data with a lower white output) (Yes in step 102), the surface of the first transparent member 3 is determined to have stain or foreign matter, and the processing advances to the dust removal step (step 103) for the image reading device 100. In step 103, the first transparent member 3 is cleaned. The processing then returns to the white output verification step (step 101). When no light reception data from the light receiver 15 indicates a decrease in received light (No in step 102), the surface of the first transparent member 3 is determined to be normal without stain or foreign matter, and the processing advances to the waveform acquisition and binarization process (step 1).

The above steps (steps 101 to 103) can prevent an error in reading the distance correction chart 25.

In the above example, the processing advances to the dust removal step (step 103) for the image reading device 100 to clean the first transparent member 3 when the surface of the first transparent member 3 is determined to have stain or foreign matter. In some embodiments, the output reduction verification step (step 102) may include defining data from a light receiver 15 indicating a decrease in received light as invalid data, and the processing may advance to the waveform acquisition and binarization process (step 1). In this case, the data from the light receiver 15 is treated as invalid data in the subsequent steps.

### Embodiment 3

Embodiment 3 of the present disclosure is described with reference to the drawings.

FIG. 34 is a flowchart of processing a distance correction chart waveform in Embodiment 3.

The processing flowchart in FIG. 34 includes, between the temperature correction process (step 6) and the data output process (step 7) in the flowchart in FIG. 14, a lens joint determination process (step 301) and an invalidation process for invalidating temperature correction values acquired near a lens joint (step 302).

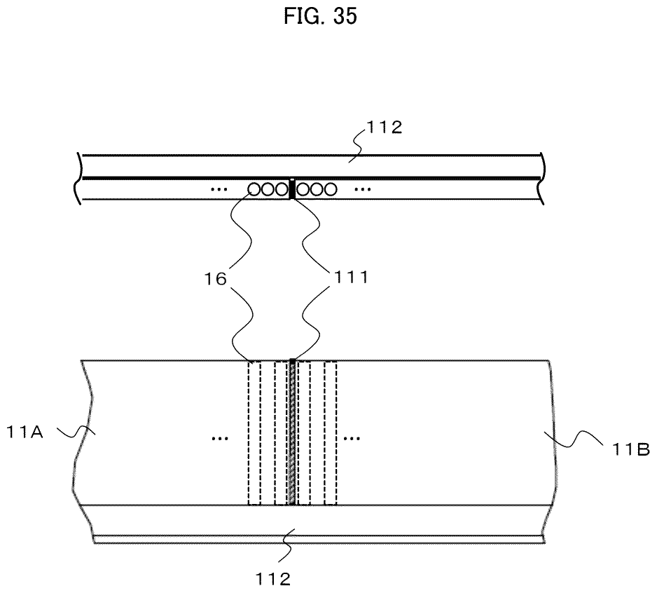

For an image reading device 100 elongated in the main scanning direction, a single rod lens array 11 cannot cover the image reading range. Thus, as illustrated in FIG. 35, multiple rod lens arrays 11 may be joined to each other to be continuous in the main scanning direction. FIG. 35 is a diagram of a rod lens array 11A and a rod lens array 11B joined to be continuous in the main scanning direction.

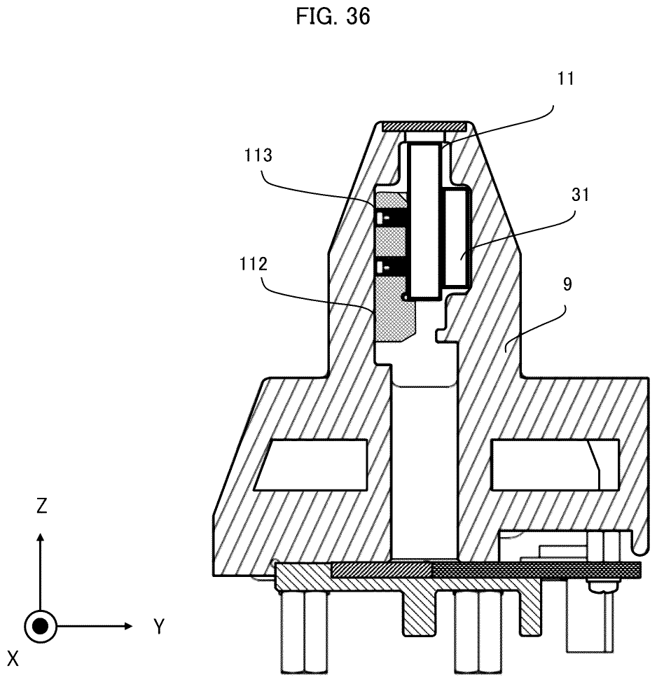

To join the multiple rod lens arrays 11 (11A and 111B) in the main scanning direction, the rod lens 11A and the rod lens 11B are joined with a seal 111. The joint between the rod lens 11A and the rod lens 11B including the seal 111 may have a joint error in joining the two rod lens arrays 11 (11A and 11B). As illustrated in FIG. 36, the image reading device 100 includes the rod lens arrays 11 (11A and 11B) pressed against the plate 31 in the sub-scanning direction with a lens plate 112 and adjustment screws 113. This structure avoids misalignment at the joint in the sub-scanning direction (Y-direction). This structure also avoids misalignment in the main scanning direction (X-direction) as well.

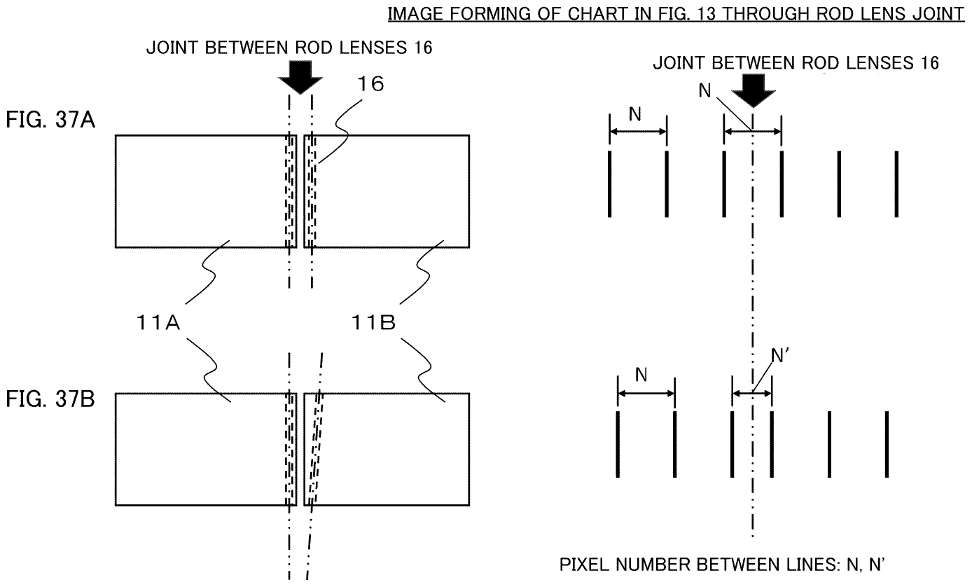

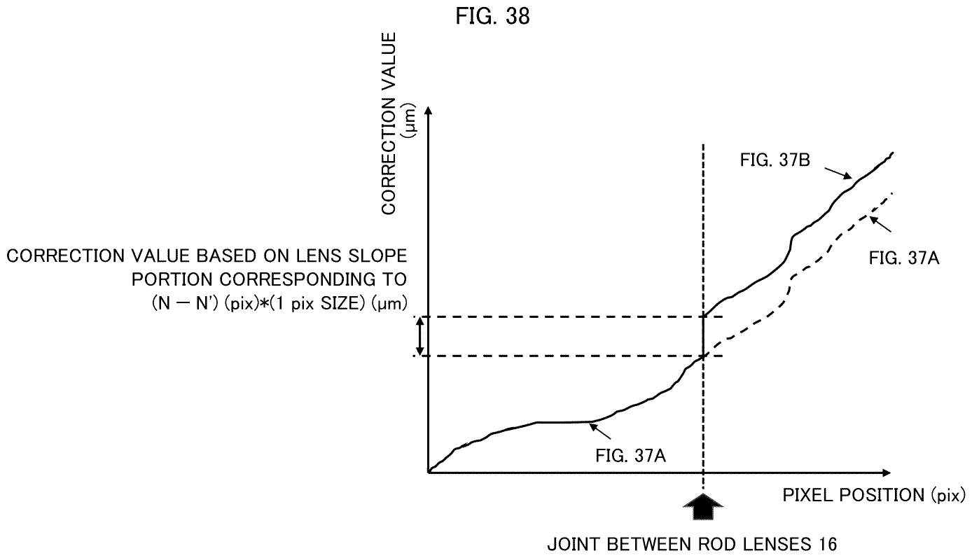

However, a joint error may occur at the joint between the rod lens arrays 11 (11A and 11B) in a direction orthogonal to the main scanning direction and the sub-scanning direction. More specifically, as illustrated in FIGS. 37A and 38B, the interval between the optical axes at one ends (for example, light incident ends) of the rod lenses 16 adjacent to each other across the joint may differ from the interval between the optical axes at the other ends (for example, light emitting ends) of the rod lenses 16.

When an interval between the optical axes at the one ends (for example, the light incident ends) of the rod lenses 16 at the joint is the same as an interval between the optical axes at the other ends (for example, the light emitting ends) of the rod lenses 16 (FIG. 37A), the image reading device 100 can undergo length measurement correction through steps 1 to 6 in FIG. 34 as in Embodiment 1.

However, when an interval between the optical axes at the one ends (for example, the light incident ends) of the rod lenses 16 at the joint differs from an interval between the optical axes at the other ends (for example, the light emitting ends) of the rod lenses 16 (FIG. 37B), the temperature correction value at the joint may have a singular point (discontinuity) as illustrated in FIG. 38.

Thus, data from a portion near the joint between the rod lens arrays 11 (11A and 11B) that may have a temperature correction value with a singular point is invalidated (for example, FAULT-DATA is forcibly input), and the processing advances to the data output process (step 7).

The joint between the rod lens arrays 11 (11A and 11B) is at a known position. Light reception data from a predetermined number of light receivers 15 including the joint is thus invalidated. For example, the light reception data from fifty light receivers on each side of the joint in the main scanning direction (more specifically, one hundred light receivers 15 in total on both sides of the joint) is invalidated (for example, FAULT-DATA is input forcibly). The processing then advances to the data output process (step 7).

More specifically, when the image reading device 100 includes multiple rod lens arrays 11 joined in the main scanning direction, the determination result indicates that the lens joint portion is included (Yes in step 301) in the lens joint determination process. The data processing device 200 then performs an invalidation process for the temperature correction value acquired near the lens joint (step S302). More specifically, data from a predetermined number of light receivers 15 including the joint of the rod lens arrays 11 is invalidated. The processing advances to the data output process (step 7) in which the measurement results of distances between the multiple points in the main scanning direction are output.

When the image reading device 100 includes a single rod lens array 11, the data processing device 200 determines that the lens joint is not included (No in step 301) in the lens joint determination process. The processing advances to the data output process (step 7). The data processing device 200 outputs the measurement results of distances between the multiple points in the main scanning direction using the results acquired in step 6.

The above processing allows measurement length correction to be performed on the image reading device 100 including multiple rod lens arrays 11 joined in the main scanning direction.

### [Appendix 1]

A distance measuring method for measuring a distance between a plurality of points in a main scanning direction based on waveform data of a black-and-white pattern on a distance correction chart read by an image reading device including pixels being light receivers arranged in the main scanning direction, the black-and-white pattern including black portions and white portions arranged at regular intervals in the main scanning direction, the distance correction chart being read with the light receivers arranged in the main scanning direction, the method comprising:
a first step of converting the waveform data to a binary waveform binarized based on a predetermined threshold;
a second step of comparing the binary waveform with the black-and-white pattern on the distance correction chart to convert, by removing noise from the binary waveform, the binary waveform to edge information including falling edges and rising edges; and
a third step of comparing the edge information with physical lengths of the black-and-white pattern of the distance correction chart to derive a number of pixels being the light receivers corresponding to a physical interval between black portions of the distance correction chart adjacent to each other in the main scanning direction.

### [Appendix 2]

The distance measuring method according to appendix 1, wherein
the first step includes
   defining positions at which the white portions switch to the black portions of the distance correction chart as falling positions each with a value of the binary waveform switching from 1 to 0, and
   defining positions at which the black portions switch to the white portions of the distance correction chart as rising positions each with a value of the binary waveform switching from 0 to 1.

### [Appendix 3]

The distance measuring method according to appendix 1 or 2, wherein
the second step includes
   a 21st step of enabling, during scanning performed in the main scanning direction by the image reading device, detection of a falling edge of the falling edges when the scanning reaches a predetermined measurement start pixel, the falling edge being a starting point of a first black portion of the black portions in the main scanning direction,
   a 22nd step of invalidating, when the falling edge is detected, light reception data acquired at pixels subsequent to the pixel at which the falling edge is detected,
   a 23rd step of validating the light reception data when the scanning reaches an endpoint prediction pixel of the first black portion in the main scanning direction subsequently to the detection of the falling edge, and enabling detection of a rising edge of the rising edges, and
   a 24th step of invalidating, when the rising edge is detected, the light reception data acquired at pixels subsequent to the pixel at which the rising edge is detected, or invalidating the light reception data when the scanning exceeds a range corresponding to the endpoint prediction pixel of the first black portion in the main scanning direction without detecting the rising edge, and
when the scanning reaches a measurement start pixel of a second black portion next to the first black portion in the scanning direction, the 21st step, the 22nd step, the 23rd step, and the 24th step are repeated.

### [Appendix 4]

The distance measuring method according to any one of appendices 1 to 3, wherein
the third step includes
   a 31st step of deleting, of the falling edges, a falling edge for which a rising edge corresponding to and adjacent to the falling edge is undetected,
   a 32nd step of defining, as a pixel position of a black portion, a position represented by an average value of a position of a falling detection pixel and a position of a rising detection pixel, the falling detection pixel being, of the pixels, a pixel at which a falling edge for the black portion is detected, the rising detection pixel being, of the pixels, a pixel at which a rising edge corresponding to and adjacent to the falling edge is detected,
   a 33rd step of deriving pixel positions of the black portions by performing processing in the 32nd step on the falling edges and the rising edges repeatedly detected in the second step, and
   a 34th step of comparing an interval between the pixel positions of the black portions with the physical interval between the black portions of the distance correction chart, determining, when the interval between the pixel positions of the black portions is equal to the physical interval between the black portions of the distance correction chart, a number of pixels between the pixel positions of adjacent black portions of the black portions as a number of pixels corresponding to the physical interval between the black portions of the distance correction chart, and determining, when the interval between the pixel positions of the black portions is an integer multiple of 2 or greater of the physical interval between the black portions of the distance correction chart, a number of pixels between a pixel position of an interpolated black portion and a pixel position of an adjacent black portion as the number of pixels corresponding to the physical interval between the black portions of the distance correction chart.

### [Appendix 5]

The distance measuring method according to any one of appendices 1 to 4, further comprising:
a fourth step of determining, in a range from a first pixel position to a last pixel position in the main scanning direction, whether a black portion of the distance correction chart is detected within a range between a predetermined expected position of a black portion on a first-pixel side and a predetermined expected position of a black portion on a last-pixel side.

### [Appendix 6]

The distance measuring method according to any one of appendices 1 to 5, further comprising:
a fifth step of arranging a plurality of the distance correction charts in the main scanning direction and combining pieces of data about a number of pixels corresponding to an interval between the black portions of each of the plurality of distance correction charts.

### [Appendix 7]

The distance measuring method according to any one of appendices 1 to 5, further comprising:
a fifth step of arranging a plurality of the distance correction charts in the main scanning direction and combining pieces of data about a number of pixels corresponding to the physical interval between the black portions of each of the plurality of distance correction charts.

### [Appendix 8]

The distance measuring method according to any one of appendices 1 to 7, further comprising:
a sixth step of correcting the number of pixels corresponding to the physical interval between the black portions of the distance correction chart based on preacquired temperature-dependent data about displacements of the pixels in the image reading device in the main scanning direction.

### [Appendix 9]

The distance measuring method according to any one of appendices 1 to 8, further comprising:
reading, before the first step, a white chart with the image reading device and verifying a white output from the image reading device;
determining, when light reception data has a lower white output from the light receivers, that stain or foreign matter is on a first transparent member in the image reading device and proceeding to cleaning of the first transparent member to remove the stain or the foreign matter before re-verifying the white output; and
determining, when the light reception data has no lower white output from the light receivers, that the first transparent member is normal and proceeding to the first step.

### [Appendix 10]

The distance measuring method according to appendix 8, further comprising:
determining, after the sixth step, whether the image reading device includes a lens joint at which a plurality of rod lens arrays are joined in the main scanning direction;
invalidating, when the lens joint is determined as being included, light reception data from a predetermined number of the light receivers including the lens joint to output a result of measuring the distance between the plurality of points in the main scanning direction; and
using, when the lens joint is determined as not being included, a result acquired in the sixth step to output a result of measuring the distance between the plurality of points in the main scanning direction.

### [Appendix 11]

The distance measuring method according to appendix 10, wherein
data indicating whether the lens joint is included is input in advance.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2023-064812, filed on Apr. 12, 2023, and Japanese Patent Application No. 2024-009960, filed on Jan. 26, 2024, the entire disclosure of which is incorporated by reference herein.

### REFERENCE SIGNS LIST

100 Image reading device
2 Side plate
3 First transparent member
4 Chart
5 Output waveform of chart 4
7 Second frame
8 Light source
9 First frame
10 Second transparent member
11, 11A, 11B Rod lens array
12 Substrate support plate
13 Substrate
14 Substrate
15 Light receiver
16 Rod lens
17 Fixing side plate
18 Document
19 Erect unity magnification image of document 18
20 Table reliably adjusted to be flat
21 Fastener
22 Fastener
23 Infrared sensor
24 Rail
25 Distance correction chart
26 Black line
27 White solid portion
28 Black scratch
29 Effective starting black line in second measurement
30 Last black line in first measurement
31 Plate
111 Seal
112 Lens plate
113 Adjustment screw
200 Data processing device
210 Processor
211 Correction data generator
212 Distance measurer
220 Storage
221 Distance correction data
1000 Distance measurement system

1. A distance measuring method for measuring a distance between a plurality of points in a main scanning direction based on waveform data of a black-and-white pattern on a distance correction chart read by an image reading device including pixels being light receivers arranged in the main scanning direction, the black-and-white pattern including black portions and white portions arranged at regular intervals in the main scanning direction, the distance correction chart being read with the light receivers arranged in the main scanning direction, the method comprising:
a first step of converting the waveform data to a binary waveform binarized based on a predetermined threshold;
a second step of comparing the binary waveform with the black-and-white pattern on the distance correction chart to convert, by removing noise from the binary waveform, the binary waveform to edge information including falling edges and rising edges; and
a third step of comparing the edge information with physical lengths of the black-and-white pattern of the distance correction chart to derive a number of pixels being the light receivers corresponding to a physical interval between black portions of the distance correction chart adjacent to each other in the main scanning direction.

2. The distance measuring method according to claim 1, wherein
the first step includes
defining positions at which the white portions switch to the black portions of the distance correction chart as falling positions each with a value of the binary waveform switching from 1 to 0, and
defining positions at which the black portions switch to the white portions of the distance correction chart as rising positions each with a value of the binary waveform switching from 0 to 1.

3. The distance measuring method according to claim 1, wherein
the second step includes
a 21st step of enabling, during scanning performed in the main scanning direction by the image reading device, detection of a falling edge of the falling edges when the scanning reaches a predetermined measurement start pixel, the falling edge being a starting point of a first black portion of the black portions in the main scanning direction,
a 22nd step of invalidating, when the falling edge is detected, light reception data acquired at pixels subsequent to the pixel at which the falling edge is detected,
a 23rd step of validating the light reception data when the scanning reaches an endpoint prediction pixel of the first black portion in the main scanning direction subsequently to the detection of the falling edge, and enabling detection of a rising edge of the rising edges, and
a 24th step of invalidating, when the rising edge is detected, the light reception data acquired at pixels subsequent to the pixel at which the rising edge is detected, or invalidating the light reception data when the scanning exceeds a range corresponding to the endpoint prediction pixel of the first black portion in the main scanning direction without detecting the rising edge, and
when the scanning reaches a measurement start pixel of a second black portion next to the first black portion in the scanning direction, the 21st step, the 22nd step, the 23rd step, and the 24th step are repeated.

4. The distance measuring method according to claim 1, wherein
the third step includes
a 31st step of deleting, of the falling edges, a falling edge for which a rising edge corresponding to and adjacent to the falling edge is undetected,
a 32nd step of defining, as a pixel position of a black portion, a position represented by an average value of a position of a falling detection pixel and a position of a rising detection pixel, the falling detection pixel being, of the pixels, a pixel at which a falling edge for the black portion is detected, the rising detection pixel being, of the pixels, a pixel at which a rising edge corresponding to and adjacent to the falling edge is detected,
a 33rd step of deriving pixel positions of the black portions by performing processing in the 32nd step on the falling edges and the rising edges repeatedly detected in the second step, and
a 34th step of comparing an interval between the pixel positions of the black portions with the physical interval between the black portions of the distance correction chart, determining, when the interval between the pixel positions of the black portions is equal to the physical interval between the black portions of the distance correction chart, a number of pixels between the pixel positions of adjacent black portions of the black portions as a number of pixels corresponding to the physical interval between the black portions of the distance correction chart, and determining, when the interval between the pixel positions of the black portions is an integer multiple of 2 or greater of the physical interval between the black portions of the distance correction chart, a number of pixels between a pixel position of an interpolated black portion and a pixel position of an adjacent black portion as the number of pixels corresponding to the physical interval between the black portions of the distance correction chart.

5. The distance measuring method according to claim 1, further comprising:
a fourth step of determining, in a range from a first pixel position to a last pixel position in the main scanning direction, whether a black portion of the distance correction chart is detected within a range between a predetermined expected position of a black portion on a first-pixel side and a predetermined expected position of a black portion on a last-pixel side.

6. The distance measuring method according to claim 1, further comprising:
a fifth step of arranging a plurality of the distance correction charts in the main scanning direction and combining pieces of data about a number of pixels corresponding to an interval between the black portions of each of the plurality of distance correction charts.

7. The distance measuring method according to claim 1, further comprising:
a fifth step of arranging a plurality of the distance correction charts in the main scanning direction and combining pieces of data about a number of pixels corresponding to the physical interval between the black portions of each of the plurality of distance correction charts.

8. The distance measuring method according to claim 1, further comprising:
a sixth step of correcting the number of pixels corresponding to the physical interval between the black portions of the distance correction chart based on preacquired temperature-dependent data about displacements of the pixels in the image reading device in the main scanning direction.

9. The distance measuring method according to claim 1, further comprising:
reading, before the first step, a white chart with the image reading device and verifying a white output from the image reading device;
determining, when light reception data has a lower white output from the light receivers, that stain or foreign matter is on a first transparent member in the image reading device and proceeding to cleaning of the first transparent member to remove the stain or the foreign matter before re-verifying the white output; and
determining, when the light reception data has no lower white output from the light receivers, that the first transparent member is normal and proceeding to the first step.

10. The distance measuring method according to claim 8, further comprising:
determining, after the sixth step, whether the image reading device includes a lens joint at which a plurality of rod lens arrays are joined in the main scanning direction;
invalidating, when the lens joint is determined as being included, light reception data from a predetermined number of the light receivers including the lens joint to output a result of measuring the distance between the plurality of points in the main scanning direction; and
using, when the lens joint is determined as not being included, a result acquired in the sixth step to output a result of measuring the distance between the plurality of points in the main scanning direction.

11. The distance measuring method according to claim 10, wherein
data indicating whether the lens joint is included is input in advance.

12. A distance measuring method for measuring a distance between a plurality of points in an x-direction being a measurement direction based on waveform data of a black-and-white pattern on a distance correction chart, the black-and-white pattern including black portions and white portions arranged at regular intervals in the x-direction, the distance correction chart being read with the light receivers arranged in the x-direction, the method comprising:
a first step of converting the waveform data to a binary waveform binarized based on a predetermined threshold;
a second step of comparing the binary waveform with the black-and-white pattern on the distance correction chart to convert, by removing noise from the binary waveform, the binary waveform to edge information including falling edges and rising edges; and
a third step of comparing the edge information with physical lengths of the black-and-white pattern of the distance correction chart to derive a number of the light receivers corresponding to a physical interval between black portions of the distance correction chart adjacent to each other in the x-direction.

13. The distance measuring method according to claim 2, wherein
the second step includes
a 21st step of enabling, during scanning performed in the main scanning direction by the image reading device, detection of a falling edge of the falling edges when the scanning reaches a predetermined measurement start pixel, the falling edge being a starting point of a first black portion of the black portions in the main scanning direction,
a 22nd step of invalidating, when the falling edge is detected, light reception data acquired at pixels subsequent to the pixel at which the falling edge is detected,
a 23rd step of validating the light reception data when the scanning reaches an endpoint prediction pixel of the first black portion in the main scanning direction subsequently to the detection of the falling edge, and enabling detection of a rising edge of the rising edges, and
a 24th step of invalidating, when the rising edge is detected, the light reception data acquired at pixels subsequent to the pixel at which the rising edge is detected, or invalidating the light reception data when the scanning exceeds a range corresponding to the endpoint prediction pixel of the first black portion in the main scanning direction without detecting the rising edge, and
when the scanning reaches a measurement start pixel of a second black portion next to the first black portion in the scanning direction, the 21st step, the 22nd step, the 23rd step, and the 24th step are repeated.

14. The distance measuring method according to claim 2, wherein
the third step includes
a 31st step of deleting, of the falling edges, a falling edge for which a rising edge corresponding to and adjacent to the falling edge is undetected,
a 32nd step of defining, as a pixel position of a black portion, a position represented by an average value of a position of a falling detection pixel and a position of a rising detection pixel, the falling detection pixel being, of the pixels, a pixel at which a falling edge for the black portion is detected, the rising detection pixel being, of the pixels, a pixel at which a rising edge corresponding to and adjacent to the falling edge is detected,
a 33rd step of deriving pixel positions of the black portions by performing processing in the 32nd step on the falling edges and the rising edges repeatedly detected in the second step, and
a 34th step of comparing an interval between the pixel positions of the black portions with the physical interval between the black portions of the distance correction chart, determining, when the interval between the pixel positions of the black portions is equal to the physical interval between the black portions of the distance correction chart, a number of pixels between the pixel positions of adjacent black portions of the black portions as a number of pixels corresponding to the physical interval between the black portions of the distance correction chart, and determining, when the interval between the pixel positions of the black portions is an integer multiple of 2 or greater of the physical interval between the black portions of the distance correction chart, a number of pixels between a pixel position of an interpolated black portion and a pixel position of an adjacent black portion as the number of pixels corresponding to the physical interval between the black portions of the distance correction chart.

15. The distance measuring method according to claim 3, wherein
the third step includes
a 31st step of deleting, of the falling edges, a falling edge for which a rising edge corresponding to and adjacent to the falling edge is undetected,
a 32nd step of defining, as a pixel position of a black portion, a position represented by an average value of a position of a falling detection pixel and a position of a rising detection pixel, the falling detection pixel being, of the pixels, a pixel at which a falling edge for the black portion is detected, the rising detection pixel being, of the pixels, a pixel at which a rising edge corresponding to and adjacent to the falling edge is detected,
a 33rd step of deriving pixel positions of the black portions by performing processing in the 32nd step on the falling edges and the rising edges repeatedly detected in the second step, and
a 34th step of comparing an interval between the pixel positions of the black portions with the physical interval between the black portions of the distance correction chart, determining, when the interval between the pixel positions of the black portions is equal to the physical interval between the black portions of the distance correction chart, a number of pixels between the pixel positions of adjacent black portions of the black portions as a number of pixels corresponding to the physical interval between the black portions of the distance correction chart, and determining, when the interval between the pixel positions of the black portions is an integer multiple of 2 or greater of the physical interval between the black portions of the distance correction chart, a number of pixels between a pixel position of an interpolated black portion and a pixel position of an adjacent black portion as the number of pixels corresponding to the physical interval between the black portions of the distance correction chart.

16. The distance measuring method according to claim 2, further comprising:
a fourth step of determining, in a range from a first pixel position to a last pixel position in the main scanning direction, whether a black portion of the distance correction chart is detected within a range between a predetermined expected position of a black portion on a first-pixel side and a predetermined expected position of a black portion on a last-pixel side.

17. The distance measuring method according to claim 3, further comprising:
a fourth step of determining, in a range from a first pixel position to a last pixel position in the main scanning direction, whether a black portion of the distance correction chart is detected within a range between a predetermined expected position of a black portion on a first-pixel side and a predetermined expected position of a black portion on a last-pixel side.

18. The distance measuring method according to claim 4, further comprising:
a fourth step of determining, in a range from a first pixel position to a last pixel position in the main scanning direction, whether a black portion of the distance correction chart is detected within a range between a predetermined expected position of a black portion on a first-pixel side and a predetermined expected position of a black portion on a last-pixel side.
